(19) United States
(12) Patent Application Publication
(10) Pub. No.: US 2013/0177788 A1
(43) Pub. Date: Jul. 11, 2013

(54) NONAQUEOUS SECONDARY BATTERY

(71) Applicants: Satomi Hasegawa, Osaka-shi (JP); Naoto Torata, Osaka-shi (JP); Satoshi Arima, Osaka-shi (JP)

(72) Inventors: Satomi Hasegawa, Osaka-shi (JP); Naoto Torata, Osaka-shi (JP); Satoshi Arima, Osaka-shi (JP)

(73) Assignee: SHARP KABUSHIKI KAISHA, Osaka (JP)

(21) Appl. No.: 13/535,849

(22) Filed: Jun. 28, 2012

(30) Foreign Application Priority Data
Jun. 29, 2011 (JP) 2011-144568

(51) Int. Cl. H01M 2/34

(52) U.S. Cl. CPC H01M 2/348
USPC 429/62

(57) ABSTRACT

A nonaqueous secondary cell comprising: an electrode including a current collector that has a multi-layered structure in which an electrically conductive layer is formed on both sides of an insulating layer, and an active material layer formed on the current collector; a through-member configured from an electrically conductive material and passing through the current collector in the thickness direction; and a tab electrode electrically connected with the electrode; a plurality of the electrodes being stacked; and asperities being provided on the surface of the through-member.

This application is based on Japanese Patent Application No. 2011-144568 filed on Jun. 29, 2011, the contents of which are hereby incorporated by reference.

### BACKGROUND OF THE INVENTION

1. Field of the Invention

The present invention relates to a nonaqueous secondary cell.

2. Description of the Prior Art

Nonaqueous secondary cells, typified by lithium ion secondary cells, have high capacity and high energy density, and have excellent characteristics such as storage performance and the ability to repeatedly charge and discharge electricity. Nonaqueous secondary cells are therefore widely utilized in portable appliances and other consumer appliances. In recent years, because of the rise in awareness relating to environmental problems and energy conservation, lithium ion secondary cells have come to be utilized in power storage applications and onboard applications in electric automobiles and the like.

Because of the high energy density of nonaqueous secondary cells, they have a high risk of abnormal heat generation, igniting, and other adverse events when exposed to an overcharged state or a high-temperature environment. Therefore, various countermeasures pertaining to safety have been taken with nonaqueous secondary cells.

Conventionally, there have been proposed lithium ion secondary cells that use a current collector having a multi-layered structure in order to prevent ignition due to abnormal heat generation (see Patent Literature 1, for example).

Patent Literature 1 proposes a lithium ion secondary cell that uses a current collector in which a metal layer is formed on both sides of a resin film having a low melting point of 130 to 170° C. When abnormal heat generation occurs in an overcharged state, a high-temperature state, or other state in this lithium ion secondary cell, the low-melting-point resin film melts. The electrodes fail due to the melting of the resin film. The electric current is thereby cut, the increase in temperature of the cell interior is therefore suppressed, and ignition is prevented.

Patent Document 1: Japanese Laid-open Patent Application No. 11-102711

As described above, the current collector proposed in Patent Document 1 is extremely effective as a safety countermeasure of a nonaqueous secondary cell.

However, since the above-described current collector has a configuration in which a metal layer is formed on both sides of the insulating resin film, a stacked nonaqueous secondary cell in which a plurality of electrodes are stacked, for example, is subject to an inconvenience in that electrical conduction among the electrodes cannot be established when a tab electrode used as a wiring lead is connected to the current collector. Therefore, this is a problem in that cell performance decreases significantly because it is difficult to electrically connect the tab electrode with all the electrodes.

### SUMMARY OF THE INVENTION

The present invention was devised in order to resolve problems such as the one described above, it being an object of the invention to provide a nonaqueous secondary cell capable of suppressing decreases in cell performance while improving safety.

To achieve the object described above, the nonaqueous secondary cell according to a first aspect of the invention comprises: an electrode including a current collector that has a multi-layered structure in which an electrically conductive layer is formed on both sides of an insulating layer, and an active material layer formed on the current collector; a through-member configured from an electrically conductive material and passing through the current collector in the thickness direction; and a tab electrode electrically connected with the electrode. A plurality of the electrodes are stacked, and asperities are provided on the surface of the through-member.

In the nonaqueous secondary cell according to the first aspect, providing the through-member which passes through the current collectors in the thickness direction as described above enables the electrically conductive layer on one side and the electrically conductive layer on the other side of the insulating layer in each of the current collectors to be electrically connected via the through-member. Therefore, due to the through-member being passed through the electrodes, electrical conduction among a plurality of stacked electrodes can be established even when current collectors having multi-layered structures are used. The tab electrode can thereby be electrically connected with the plurality of stacked electrodes. For example, the tab electrode can be electrically connected with all stacked electrodes of the same polarity. Consequently, decreases in cell performance can be suppressed, and the nonaqueous secondary cell can be put into practical application with maximum performance.

In the first aspect, the contact surface area between the through-member and the electrodes (the electrically conductive layers) can be increased by providing the asperities in the surface of the through-member, and contact resistance between the through-member and the electrodes (the electrically conductive layers) can therefore be reduced. Therefore, contact resistance can be reduced in electrodes other than the electrode in contact with the tab electrode. Therefore, electrical conduction can be established among the plurality of stacked electrodes via the through-member, and the tab electrode can therefore be electrically connected with the plurality of stacked electrodes. As a result, decreases in cell performance can be further suppressed, and a lithium ion secondary cell having little loss of characteristics can be obtained (produced).

Furthermore, in the first aspect, due to current collectors having multi-layered structures being used, when an abnormal amount of heat is generated in an overcharged state, a high-temperature state, or the like, for example, the insulating layers of the current collectors melt and the electrodes fail, and electric current is therefore cut off. Temperature increases in the cell interior can thereby be suppressed, and the occurrence of fire and other abnormal states can therefore be prevented.

In the first aspect, due to the through-member described above being provided, when the tab electrode is connected to an electrode by welding or the like, for example, the contact resistance between the tab electrode and the electrode and the contact resistance between electrodes can be reduced. It is thereby possible to connect the tab electrode to the electrode with strong electrical conduction. Due to the tab electrode being strongly connected with electrical conduction to the electrode, it is possible to suppress decreases in cell capacity originating from increases in contact resistance.

In the nonaqueous secondary cell according to the first aspect described above, the height of the asperities is preferably in a range of 0.1 μm to 5 mm. With such a configuration, contact surface area between the through-member and the electrodes can be easily increased.

In the nonaqueous secondary cell according to the first aspect described above, it is preferable that the asperities be provided at a predetermined pitch relative to the through direction of the through-member, and the pitch of the asperities be 0.1 to 2.0 times the thickness of the current collectors. With such a configuration, the convex portions of the asperities are easily disposed between electrodes, and the contact surface area between the through-member and the electrodes can therefore be efficiently increased. The contact resistance between the through-member and the electrodes can thereby be effectively reduced.

Furthermore, in the nonaqueous secondary cell according to the first aspect described above, a thread groove is formed in the through-member, and the asperities are provided in the surface of the through-member by the formation of the thread groove.

A nonaqueous secondary cell according to a second aspect of the invention comprises: an electrode including a current collector that has a multi-layered structure in which an electrically conductive layer is formed on both sides of an insulating layer, and an active material layer formed on the current collector; a through-member configured from an electrically conductive material and passing through the current collector in the thickness direction; and a tab electrode electrically connected with the electrode. A plurality of the electrodes are stacked. The through-member is deformed within the stacked electrodes, and the deformed portion of the through-member is in contact with the current collectors.

In the nonaqueous secondary cell according to the second aspect, the through-member is deformed within the stacked electrodes and the deformed portion is in contact with the current collectors, whereby the contact surface area between the through-member and the electrodes can be increased, and the contact resistance between the through-member and the electrodes can therefore be reduced. Therefore, since electrical conduction can be established among the plurality of stacked electrodes via the through-member, the tab electrode can be electrically connected with the plurality of stacked electrodes. As a result, decreases in cell performance can be suppressed.

In the nonaqueous secondary cell according to the second aspect described above, the through-member is preferably configured having a bent part that is bent within the stacked electrodes. With such a configuration, the bent portion is in contact with the current collectors, and the contact surface area between the through-member and the electrodes can therefore be easily increased.

In this case, the bent part of the through-member is preferably positioned between adjacent electrodes. With such a configuration, the contact surface area between the through-member and the electrodes can be efficiently increased. The contact resistance between the through-member and the electrodes can thereby be effectively reduced.

In the configuration in which the through-member has the bent part, a bend starting part where bending begins is preferably formed in the through-member. With such a configuration, the through-member easily bends in the bend starting part, and the through-member can therefore be bent at a desired position by providing the bend starting part to the desired position. Therefore, by providing the bend starting part so as to be positioned between mutually adjacent electrodes, for example, the through-member can be bent between the electrodes. The bent part of the through-member can thereby be easily positioned between mutually adjacent electrodes, and the contact surface area between the through-member and the electrodes can therefore be increased more easily.

The bend starting part described above can be configured from a cut-out or a concavity.

In the configuration in which the bend starting part is formed in the through-member, the through-member preferably has a plurality of through-parts passing through the stacked electrodes. In this case, a bend starting part is preferably formed in at least one of the plurality of through-parts.

In the through-member described above, the through-parts can be configured as divisions of the portion that passes through the stacked electrodes. There can be two to sixteen divisions of the portion that passes through the stacked electrodes.

As described above, according to the present invention, a nonaqueous secondary cell capable of suppressing decreases in cell performance while improving safety can be easily obtained.

### BRIEF DESCRIPTION OF THE DRAWINGS

FIG. 1 is a cross-sectional view schematically showing an electrode group of a lithium ion secondary cell according to the first embodiment of the present invention;

FIG. 2 is an exploded perspective view of the lithium ion secondary cell according to the first embodiment of the present invention;

FIG. 3 is an exploded perspective view of the electrode group of the lithium ion secondary cell according to the first embodiment of the present invention;

FIG. 4 is a perspective view schematically showing an electrode group of the lithium ion secondary cell according to the first embodiment of the present invention;

FIG. 5 is an overall perspective view of the lithium ion secondary cell according to the first embodiment of the present invention;

FIG. 6 is a cross-sectional view showing an enlargement of part of FIG. 1;

FIG. 7 is a cross-sectional view (a view corresponding to a cross section along line A-A of FIG. 9) of a cathode of the lithium ion secondary cell according to the first embodiment of the present invention;

FIG. 8 is a plan view of the cathode of the lithium ion secondary cell according to the first embodiment of the present invention;

FIG. 9 is a perspective view of the cathode of the lithium ion secondary cell according to the first embodiment of the present invention;

FIG. 10 is a plan view schematically showing part of the cathode used in the lithium ion secondary cell according to the first embodiment of the present invention;

FIG. 11 is a perspective view schematically showing part of the electrode group of the lithium ion secondary cell according to the first embodiment of the present invention;

FIG. 12 is a perspective view schematically showing part of the electrode group of the lithium ion secondary cell according to the first embodiment of the present invention;

FIG. 13 is a cross-sectional view (a view corresponding to a cross section including a through-member) schematically showing part of the electrode group of the lithium ion secondary cell according to the first embodiment of the present invention;

FIG. 14 is a perspective view showing the through-member according to the first embodiment of the present invention;

FIG. 15 is a side view of the through-member according to the first embodiment of the present invention;

FIG. 16 is a cross-sectional view showing an enlargement of part of the through-member according to the first embodiment of the present invention;

FIG. 17 is a cross-sectional view schematically showing a state in which the through-member according to the first embodiment of the present invention has been passed through a stacked cathode current collector;

FIG. 18 is a cross-sectional view (a view corresponding to the cross section along line B-B of FIG. 20) of an anode of the lithium ion secondary cell according to the first embodiment of the present invention;

FIG. 19 is a plan view of the anode of the lithium ion secondary cell according to the first embodiment of the present invention;

FIG. 20 is a perspective view of the anode of the lithium ion secondary cell according to the first embodiment of the present invention;

FIG. 21 is a plan view of a separator of the lithium ion secondary cell according to the first embodiment of the present invention;

FIG. 22 is a cross-sectional view showing an enlargement of part of a through-member according to the second embodiment of the present invention;

FIG. 23 is a cross-sectional view schematically showing a state in which the through-member according to the second embodiment of the present invention has been passed through a stack of cathode current collectors;

FIG. 24 is a cross-sectional view of the through-member according to the third embodiment of the present invention;

FIG. 25 is a cross-sectional view schematically showing a state in which the through-member according to the third embodiment of the present invention has been passed through a stack of cathode current collectors;

FIG. 26 is a side view of the through-member according to the fourth embodiment of the present invention;

FIG. 27 is a cross-sectional view schematically showing a state in which the through-member according to the fourth embodiment of the present invention has been passed through a stack of cathode current collectors;

FIG. 28 is a schematic cross-sectional view of an enlargement of part of the through-member according to the fourth embodiment of the present invention (a drawing showing an example of bend starting parts);

FIG. 29 is a schematic cross-sectional view of an enlargement of part of the through-member according to the fourth embodiment of the present invention (a drawing showing another example of bend starting parts);

FIG. 30 is a schematic cross-sectional view showing the method for mounting the through-member according to the fourth embodiment of the present invention;

FIG. 31 is a schematic cross-sectional view showing the method for mounting the through-member according to the fourth embodiment of the present invention;

FIG. 32 is a cross-sectional view schematically showing the through-member according to the fifth embodiment of the present invention;

FIG. 33 is a cross-sectional view schematically showing a state in which the through-member according to the fifth embodiment of the present invention has been passed through a stack of cathode current collectors;

FIG. 34 is a cross-sectional view schematically showing the through-member according to the sixth embodiment of the present invention;

FIG. 35 is a schematic plan view of the through-member according to the sixth embodiment of the present invention as seen from the top surface;

FIG. 36 is a cross-sectional view schematically showing the through-member according to the sixth embodiment of the present invention (with a core rod inserted therein);

FIG. 37 is a drawing for illustrating the configuration of the through-member according to the sixth embodiment of the present invention;

FIG. 38 is a drawing for illustrating the configuration of the through-member according to the sixth embodiment of the present invention;

FIG. 39 is a schematic cross-sectional view showing the method for mounting the through-member according to the sixth embodiment of the present invention; and

FIG. 40 is a schematic cross-sectional view showing the method for mounting the through-member according to the sixth embodiment of the present invention.

### DETAILED DESCRIPTION OF PREFERRED EMBODIMENTS

Embodiments that specify the present invention are described in detail hereinbelow based on the drawings. In the following embodiments, a case is described in which the present invention is applied to a stacked lithium ion secondary cell, one example of a nonaqueous secondary cell.

### First Embodiment

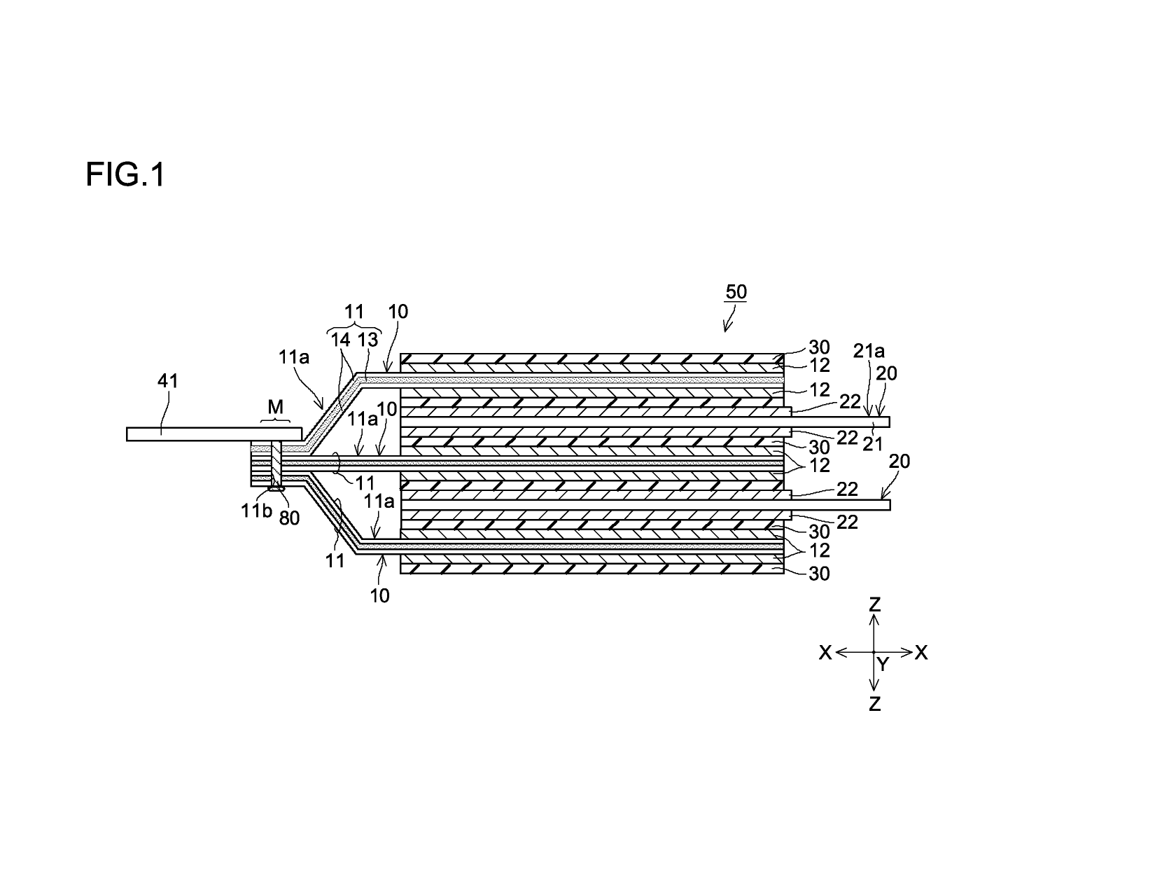

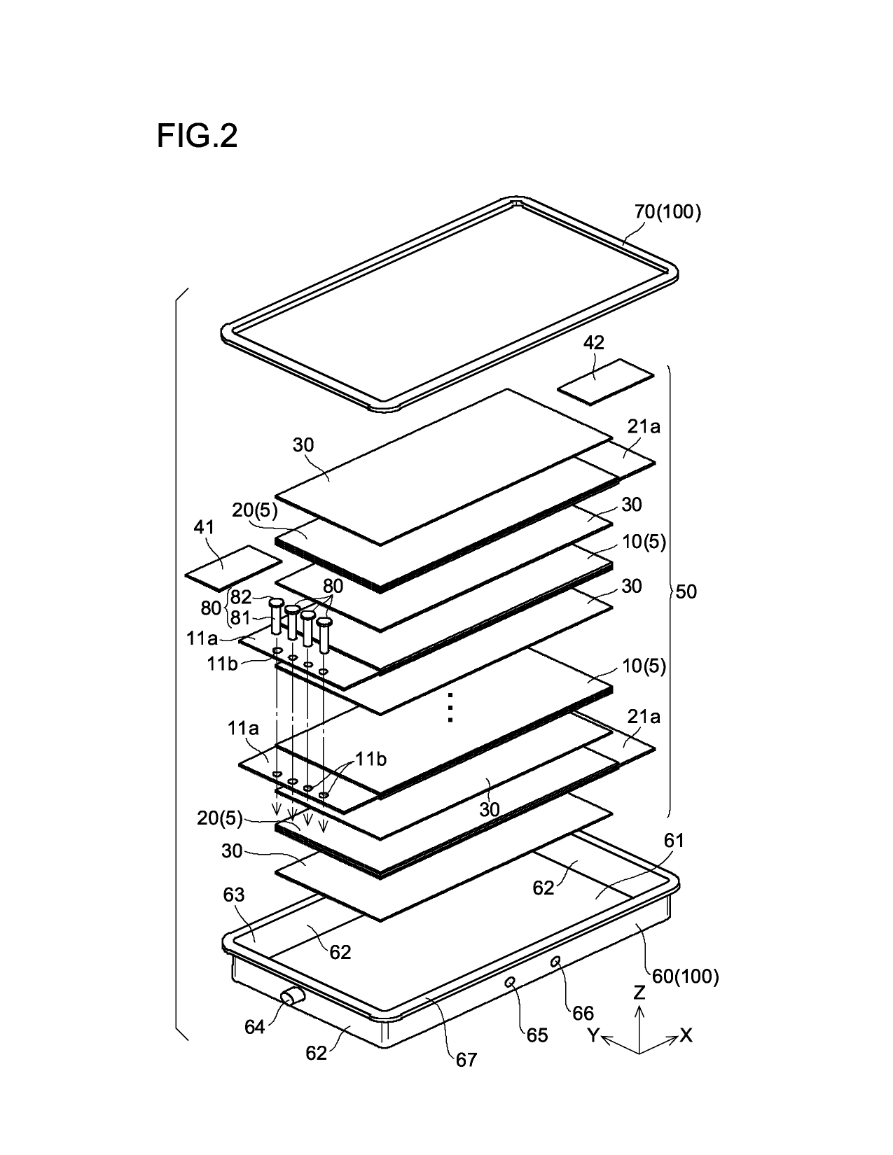

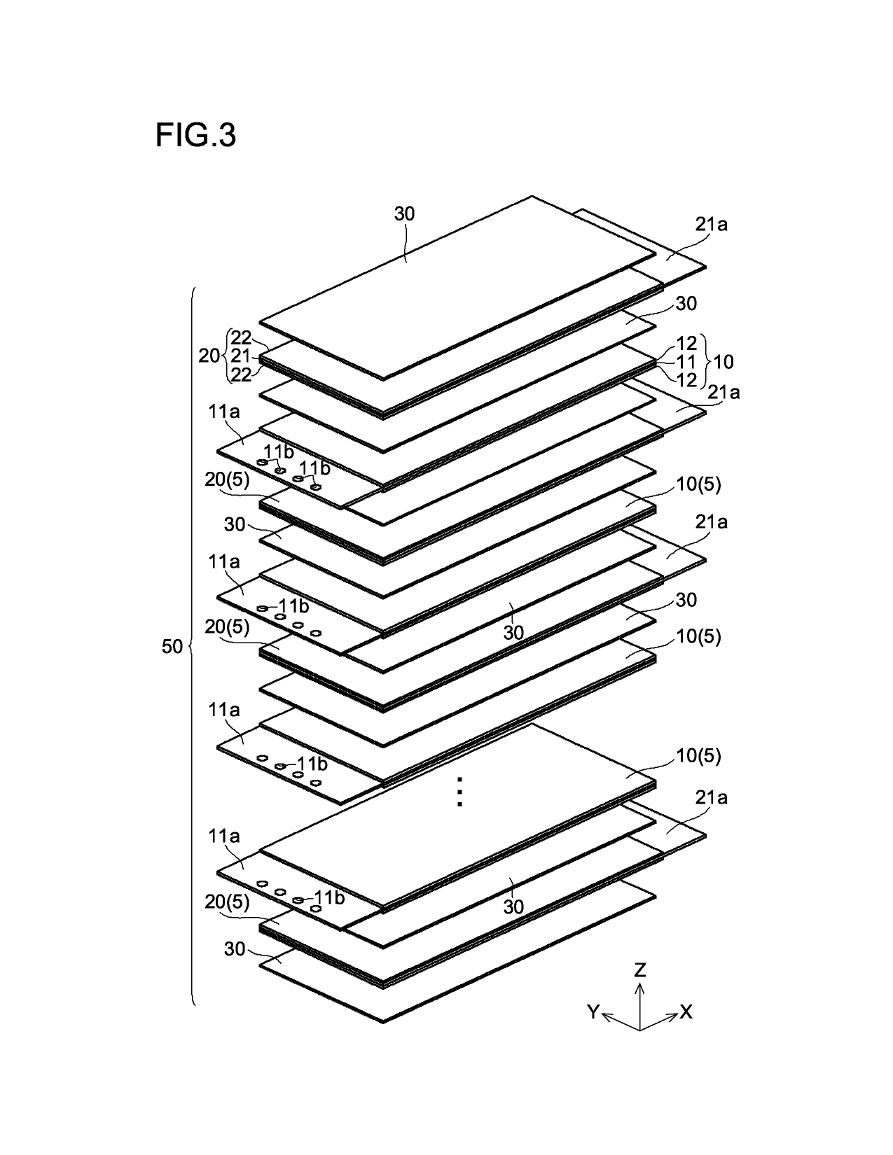

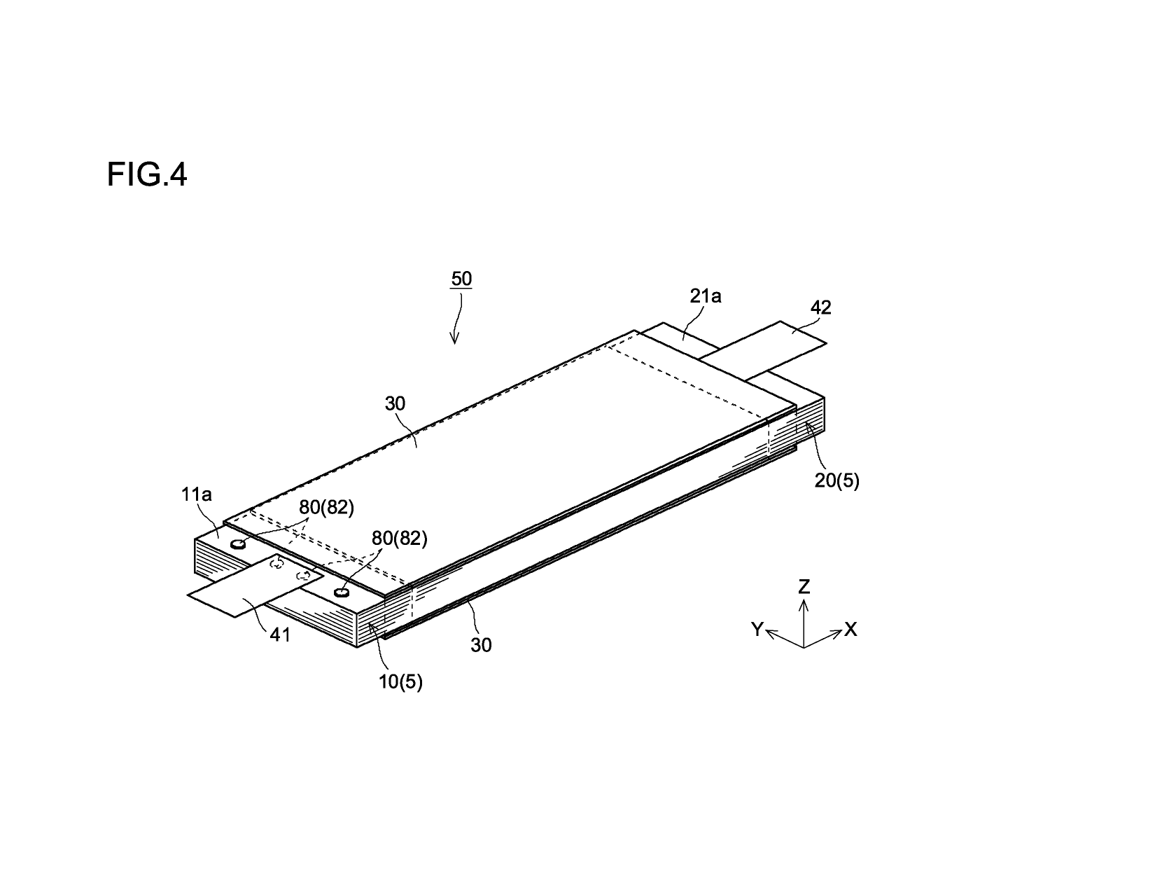

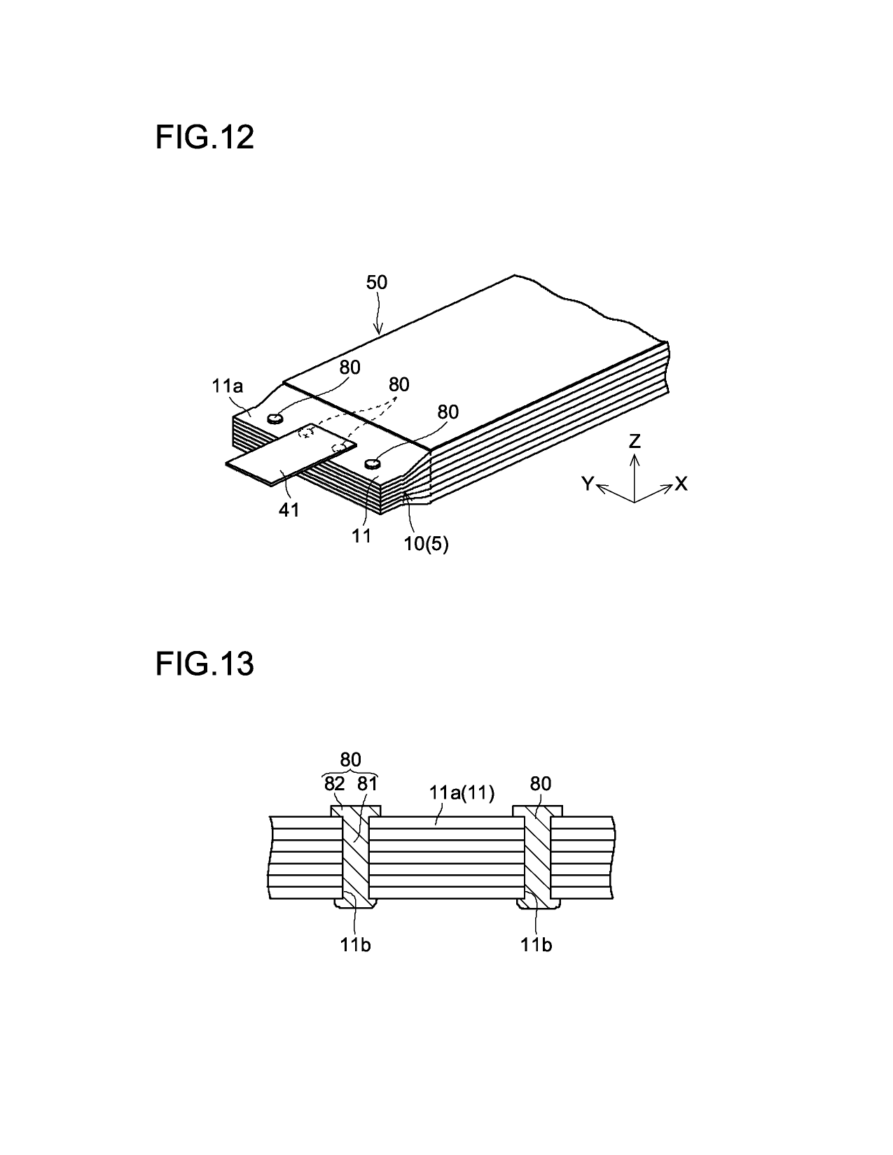

FIG. 1 is a cross-sectional view schematically showing an electrode group of a lithium ion secondary cell according to the first embodiment of the present invention. FIG. 2 is an exploded perspective view of the lithium ion secondary cell according to the first embodiment of the present invention. FIG. 3 is an exploded perspective view of the electrode group of the lithium ion secondary cell according to the first embodiment of the present invention. FIGS. 4 through 21 are views for describing the lithium ion secondary cell according to the first embodiment of the present invention. First, the lithium ion secondary cell according to the first embodiment of the present invention will be described, referring to FIGS. 1 through 21.

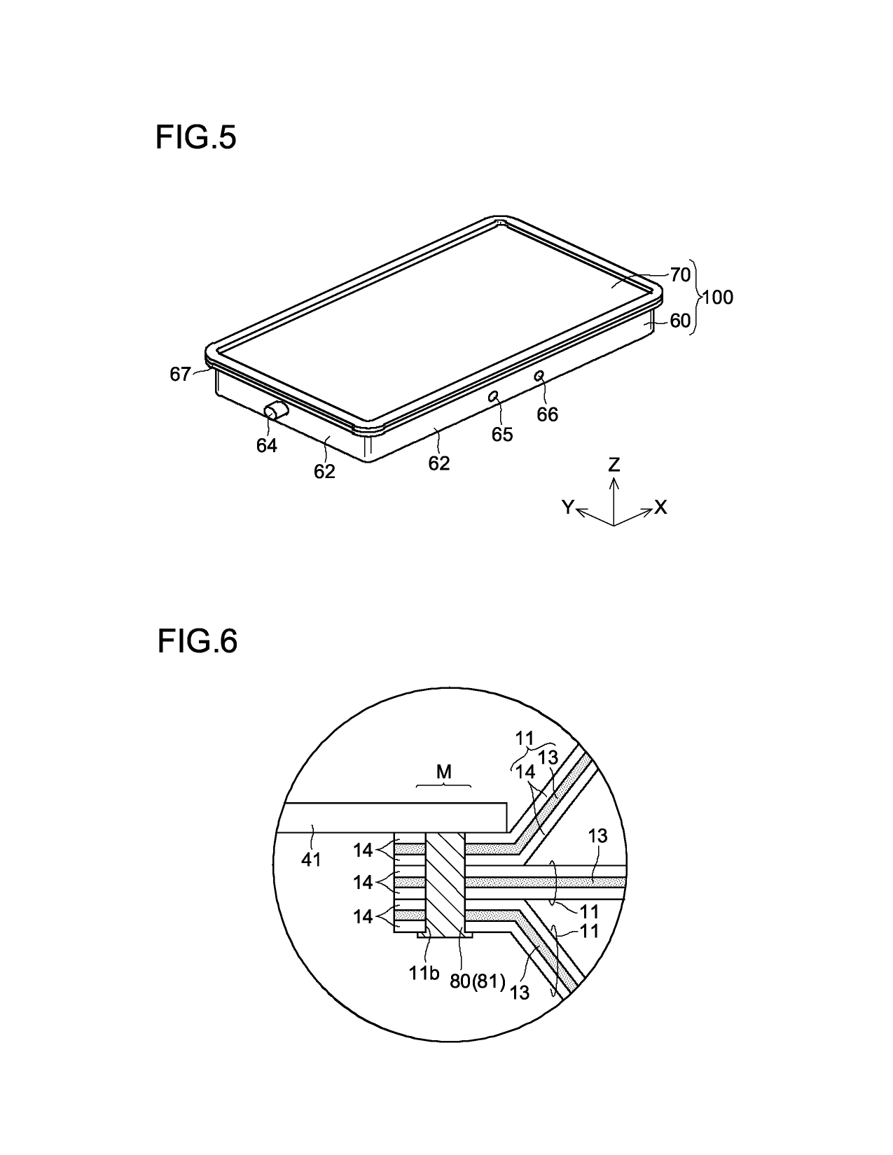

The lithium ion secondary cell according to the first embodiment is a large secondary cell having a rectangular flat shape and comprising an electrode group 50 (see FIG. 1) including a plurality of electrodes 5, and a metal external container 100 for enclosing the electrode group 50 together with a nonaqueous electrolytic solution, as shown in FIGS. 2 and 5.

The electrodes 5 as shown in FIGS. 1 through 3 are configured including cathodes 10 and anodes 20, and between the cathodes 10 and anodes 20 are placed separators 30 for suppressing short circuiting of the cathodes 10 and the anodes 20. Specifically, the cathodes 10 and the anodes 20 are placed facing each other from opposite sides of the separators 30, and are configured into a stacked structure (stacked body) due to the cathodes 10, the separators 30, and the anodes 20 being stacked sequentially. The cathodes 10 and the anodes 20 are alternatively stacked one by one. The electrode group 50 described above is configured so that one cathode 10 is positioned between two adjacent anodes 20.

The electrode group 50 described above is configured including thirteen cathodes 10, fourteen anodes 20, and twenty-eight separators 30, for example, the cathodes 10 and the anodes 20 being alternatively stacked on opposite sides of the separators 30. Furthermore, the separators 30 are placed on the outermost sides in the electrode group 50 described above (the outer sides of the outermost layer anodes 20), providing insulation relative to the external container 100.

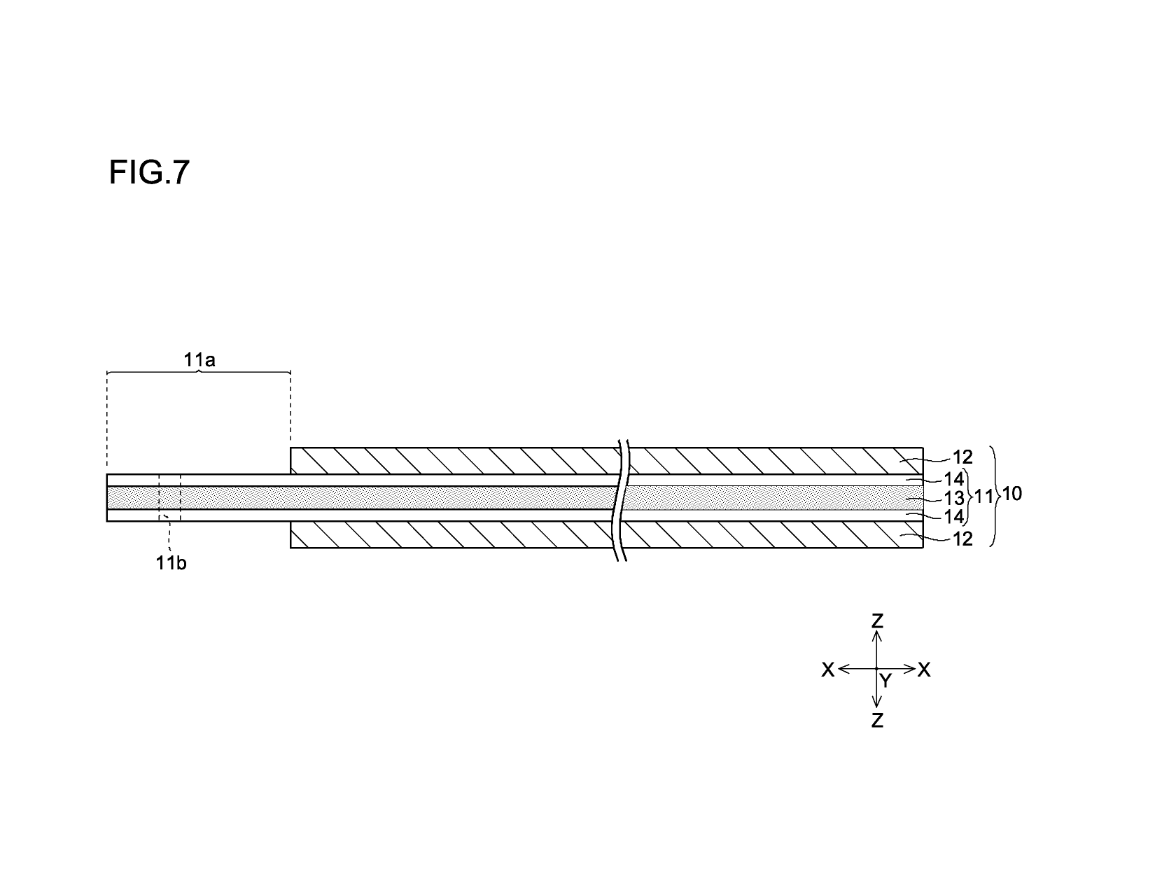

Each of the cathodes 10 constituting the electrode group 50 has a configuration in which cathode active material layers 12 are supported on both sides of an cathode current collector 11, as shown in FIG. 7.

The cathode current collector 11 has the function of collecting the current of the cathode active material layers 12.

In the first embodiment, the cathode current collector 11 described above is configured into a multi-layered structure (three-layered structure) in which electrically conductive layers 14 are formed on both sides of an insulating resin layer 13. The resin layer 13 is one example of the “insulating layer” of the present invention.

The electrically conductive layers 14 constituting the cathode current collector 11 are configured from aluminum or an aluminum alloy, for example, and are formed into a thickness of approximately 6 to 15 μm. Aluminum can be used suitably as the electrically conductive layers 14 of the cathode current collector 11 because it is highly resistant to oxidation. The electrically conductive layers 14 described above may also be a material other than aluminum or an aluminum alloy, e.g., they may be configured from titanium, stainless steel, nickel or another metal material, an alloy of these metals, or the like.

The method for forming the electrically conductive layers 14 is not particularly limited; possible examples thereof include vapor deposition, sputtering, electroplating, electroless plating, attaching metal foil, or the like; and a method composed of a combination of these methods.

The resin layer 13 of the cathode current collector 11 is configured from a plastic material consisting of a thermoplastic resin. The resin layer 13 is composed of a sheet-shaped (film-shaped) resin member (resin film), for example. Suitable examples that can be used as the plastic material composed of a thermoplastic resin include polyethylene (PE), polypropylene (PP) or another polyolefin resin, polystyrene (PS), polyvinyl chloride, polyamide, and the like, which have a heat distortion temperature of 150° C. or less. Preferred among these are polyethylene (PE), polypropylene (PP) or another polyolefin resin, polyvinyl chloride, and the like, which at 120° C. have a thermal shrinkage rate of 1.5% or more in any planar direction (e.g., either the longitudinal direction or the transverse direction). Composite films thereof and resin films whose surfaces have been processed can also be suitably used. Furthermore, resin films of the same material as the separators 30 described above can also be used. When the resins have different heat distortion temperatures, thermal shrinkage rates, and other properties due to differences in their manufacturing steps and processing, the resins can be used in both the resin layer 13 and the separators 30.

The thickness of the resin layer 13 is not particularly limited, but in order to achieve a balance between improving energy density and maintaining strength in the secondary cell, the thickness is preferably 5 μm or greater and 50 μm or less, and more preferably 10 μm or greater and 20 μm or less. The resin layer 13 (the resin film) may be a resin film manufactured by any method of uniaxial stretching, biaxial stretching, non-stretching, and the like. Instead of a film shape, the resin layer 13 of the cathode current collector 11 may also have a fibrous shape.

The terms “heat distortion temperature” and “thermal shrinkage rate” mean values obtained by the methods hereinbelow. Heat distortion temperature means a temperature at which the resin layer (the resin film) begins to thermally shrink (the heat distortion temperature and thermal shrinkage rate are the same for the separators described hereinafter).

The heat distortion temperature is measured by keeping the resin film in a thermostatic bath for a fixed time duration at a fixed temperature and measuring the thermal shrinkage rate, and repeatedly raising the temperature when there is no shrinkage and lowering the temperature when there is shrinkage. Specifically, the resin film is kept for 15 minutes at 100° C., for example, and the thermal shrinkage rate of the resin film is measured. When the thermal shrinkage rate at this time is 20% or less, a new sample is used, the temperature is raised to 105° C., and the thermal shrinkage rate is measured after keeping the resin film at this temperature for 15 minutes. This step is repeated until the temperature reaches 150° C., and the temperature at the time point when the thermal shrinkage rate is 10% or greater is designated as the heat distortion temperature.

To measure the thermal shrinkage rate, two points spaced apart by 50 mm or more on the resin film are chosen, and the distance between these two points is measured using a vernier caliper, for example. Then, after heating at 120° C. (180° C. for the separators described hereinafter) for 15 minutes, the same distance between the points is measured again, and the thermal shrinkage rate is found based on the values measured before and after heating. Based on this method, the distances between three or more points are measured in planar directions (e.g., a longitudinal direction and a transverse direction) of the resin layer (the resin film), and the average value of the thermal shrinkage rates calculated from each of the measurement results is employed as the final thermal shrinkage of the resin film. At this time, in both the longitudinal direction and transverse direction of the resin film, at least two points within 10% from the ends of the resin film and one point approximately 50% from the ends of the resin film are selected as starting points for measuring the distance between the points. Any large value in the planar directions (e.g., the longitudinal direction and the transverse direction) is designated as the thermal shrinkage rate.

The cathode active material layers 12 are configured including a cathode active material that can occlude and discharge lithium ions. An oxide that contains lithium is a possible example of the cathode active material. Specifically, possible examples include LiCoO₂, LiFeO₂, LiMnO₂, LiMn₂O₄, and compounds in which some of the transition metals in these oxides are replaced with other metal elements. Of these it is preferable that the cathode active material be one that can utilize the 80% or more of the amount of lithium contained in the anode in the cell reaction during normal use. It is thereby possible to increase the safety of the secondary cell in relation to overcharging and other accidents. Possible examples of such an cathode active material include compounds having a spinel structure such as LiMn₂O₄, compounds having an olivine structure expressed by LiₓMPO₄ (M being at least one element selected from Co, Ni, MN, and Fe), and the like. A cathode active material containing Mn and/or Fe is preferable in terms of cost. Furthermore, it is preferable to use LiFePO₄ in terms of safety and charging voltage. LiFePO₄ is not susceptible to oxygen discharge by temperature increase because all of the oxygen (O) is bonded with the phosphorus by strong covalent bonds. Therefore, LiFePO₄ has excellent safety.

The thickness of the cathode active material layers 12 described above is preferably about 20 μm to 2 mm, and more preferably about 50 μm to 1 mm.

When the cathode active material layers 12 described above include at least a cathode active material, the configuration thereof is not particularly limited. For example, other than the cathode active material, the cathode active material layers 12 may include an electrical conductor, a thickener, a binder, and other materials.

The electrical conductor is not particularly limited as long as it is an electronically conductive material that does not adversely affect the cell performance of the cathodes 10. Possible examples include: carbon black, acetylene black, ketjen black, graphite (natural graphite, synthetic graphite), carbon fibers, and other carbon materials; electroconductive metal oxides; and the like. Of these, carbon black and acetylene black are preferable as the electrical conductor in terms of their electronic conductivity and coatability.

Possible examples of the thickener include polyethylene glycols, celluloses, polyacrylamides, poly N-vinyl amides, poly N-vinyl pyrrolidones, and the like. Of these, polyethylene glycols, carboxymethyl celluloses (CMC) and other celluloses are preferable as the thickener, and CMC is particularly preferable.

The binder fulfills the role of linking active material grains and electrical conductor grains, and possible examples thereof include: polyvinylidene fluoride (PVDF), polyvinyl pyridine, polytetrafluoroethylene, and other fluoropolymers; polyethylene, polypropylene, and other polyolefin-based polymers; styrene butadiene rubber, and the like.

Possible examples of the solvent for dispersing the cathode active material, the electrical conductor, and binder, and the like include N-methyl-2-pyrrolidone, dimethyl formamide, dimethyl acetamide, methyl ethyl ketone, cyclohexanone, methyl acetate, methyl acrylate, diethyl triamine, N,N-dimethylaminopropylamine, ethylene oxide, tetrahydrofuran, and other organic solvents.

The cathodes 10 described above are formed by mixing the cathode active material, the electrical conductor, the thickener, and the binder, adding a suitable solvent to create a pasty cathode mixture, coating the surface of the cathode current collector 11 with the mixture, drying the coating, and compressing the result to increase the electrode density as necessary, for example.

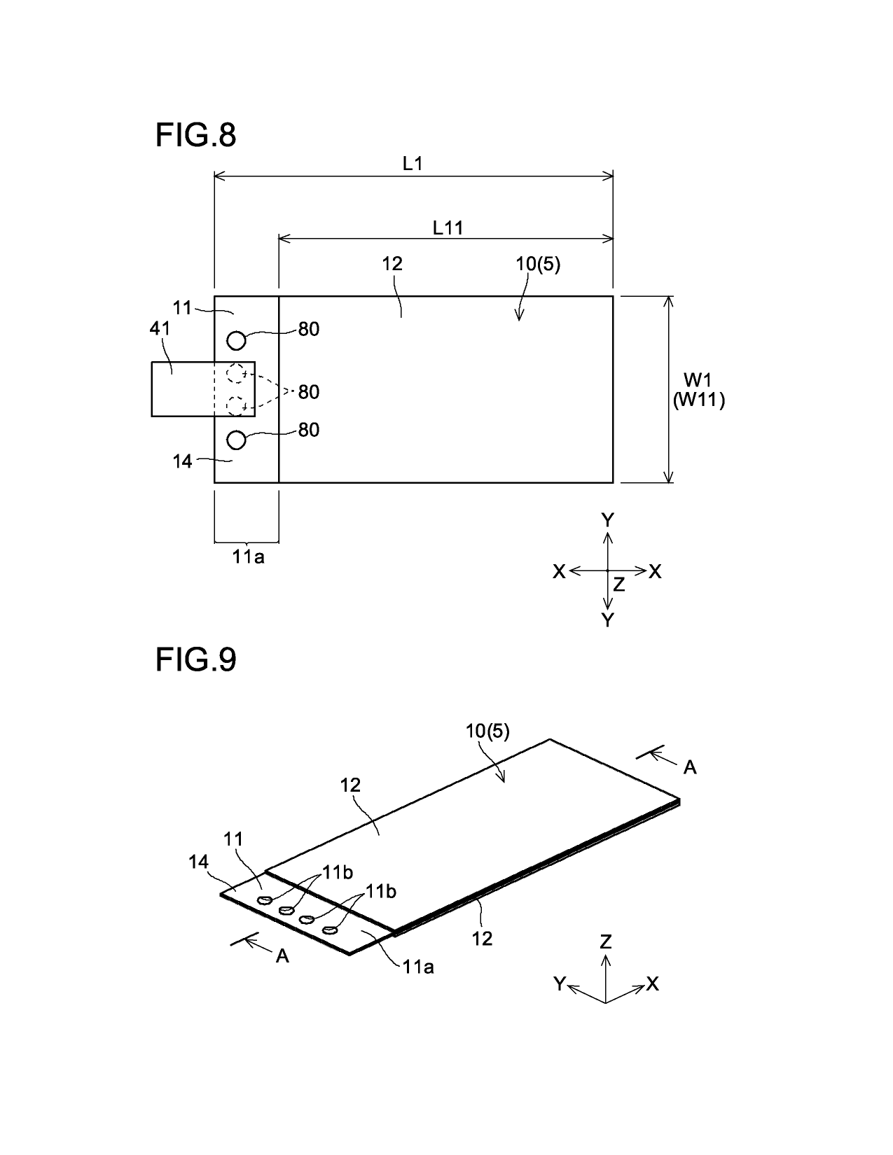

Each of the cathodes 10 described above, viewed in plan fashion, has a substantially rectangular shape as shown in FIG. 8. The width W1 of the cathode 10 in the Y direction is approximately 100 mm, for example, and the length L1 in the X direction is approximately 150 mm, for example. The coated region (formed region) of the cathode active material layer 12 has a width W11 in the Y direction equal to the width W1 of the cathode 10 at approximately 100 mm, for example, and a length L11 in the X direction of approximately 135 mm, for example.

The cathode 10 has, at one end in the X direction, a current collector exposed part (exposed region) 11a where the cathode active material layer 12 is not formed and the surface (electrically conductive layer 14) of the cathode current collector 11 is exposed, as shown in FIGS. 7 through 9. A tab electrode 41 for extracting electric current to the exterior is electrically connected to the current collector exposed part 11a. The tab electrode 41 is formed into a shape approximately 30 mm in width and approximately 70 mm in length, for example.

In the first embodiment, through-holes 11b passing through in the thickness direction are formed in the current collector exposed part 11a of the cathode 10. The through-holes 11b are formed so that when a plurality of cathodes 10 are stacked, the through-holes 11b of the cathodes 10 line up (overlap). Through-members 80 (see FIG. 1), described hereinafter, are inserted through the through-holes 11b of the cathode 10.

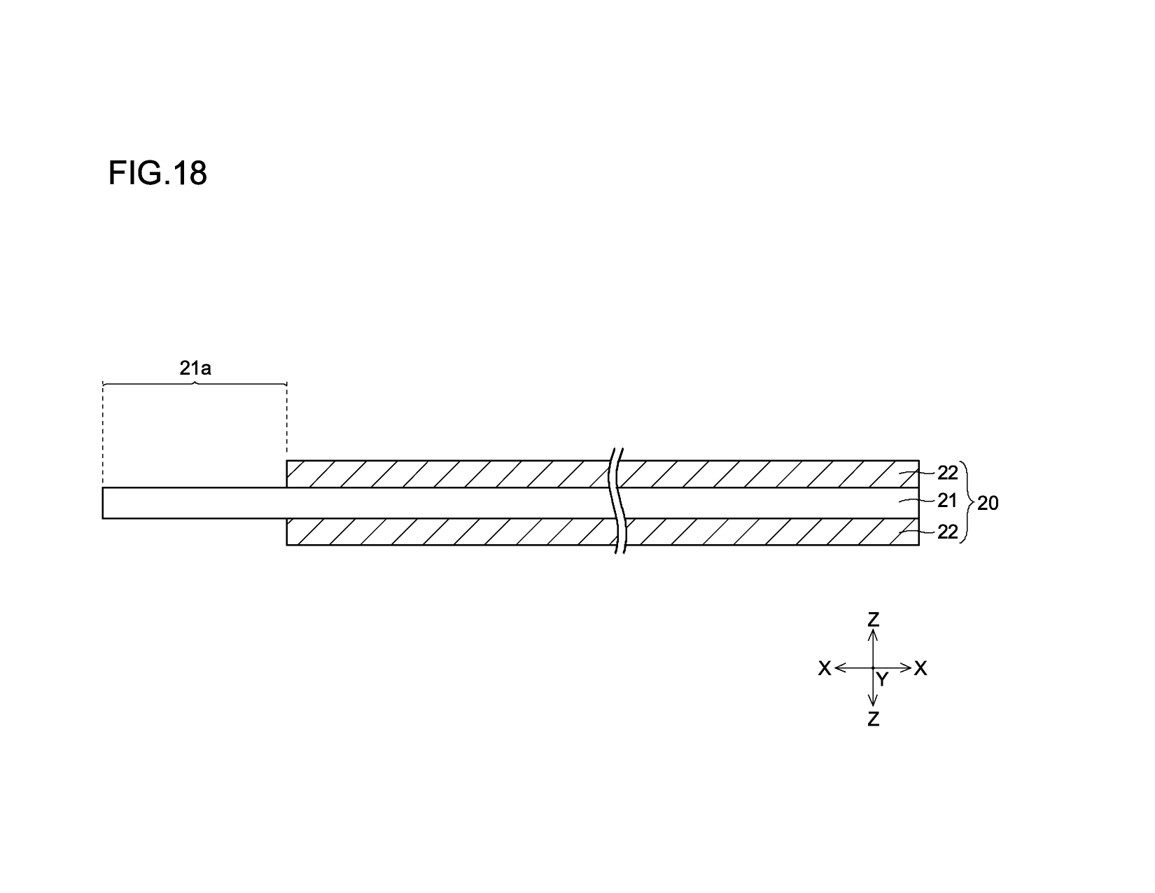

Each of the anodes 20 constituting the electrode group 50 has a configuration in which anode active material layers 22 are supported on both sides of an anode current collector 21, as shown in FIG. 18.

The anode current collector 21 has the function of collecting the currents of the anode active material layers 22.

In the first embodiment, the anode current collector 21 has a configuration that does not include a resin layer, unlike the cathode current collector 11 described above (see FIG. 7). Specifically, only the cathode current collector 11 (see FIG. 7) is configured into a multi-layered structure that includes a resin layer.

Specifically, the anode current collector 21 is configured from a metal foil of copper, nickel, stainless steel, iron, a nickel plating layer, or the like; or an alloy foil composed of an alloy of these metals. The anode current collector 21 has a thickness of approximately 1 μm to approximately 100 μm (e.g., approximately 16 μm). A metal foil composed of copper or a copper alloy is preferable for the anode current collector 21 since it tends not to alloy with lithium, and the thickness thereof is preferably 4 μm or greater and 20 μm or less.

Instead of a foil, the anode current collector 21 may be in the form of a film, a sheet, a netting, a punched or expanded article, a lath, a porous body, a foamed body, a fiber cluster formation, or the like.

The anode active material layers 22 are configured including an anode active material that can that can occlude and discharge lithium ions. The anode active material is composed of a material that includes lithium, or a material that can occlude and discharge lithium, for example. To configure a high energy density cell, the electric potential for occluding/discharging lithium is preferably near the precipitation/dissolution electric potential of metal lithium. A prime example is natural graphite or synthetic graphite in the form of grains (in the form of flakes, clumps, fibers, whiskers, spheres, ground grains, or the like). The anode active material may be synthetic graphite obtained by graphitization of mesocarbon microbeads, mesophase pitch powder, isotropic pitch powder, or the like. Graphite grains with amorphous carbon deposited on the surface can also be used. Furthermore, a lithium transition metal oxide, a lithium transition metal nitride, a transition metal oxide, silicon oxide, and the like can also be used. When lithium titanate, typified by Li₄Ti₅O₁₂, for example, is used as the lithium transition metal oxide, there is less deterioration of the anodes 20, and the life of the cell can therefore be prolonged.

The thickness of the anode active material layers 22 described above is preferably about 20 μm to 2 mm, and more preferably about 50 μm to 1 mm.

The configuration of the anode active material layers 22 described above is not particularly limited as long as it includes at least the anode active material. For example, other than the anode active material, the anode active material layers 22 may include an electrical conductor, a thickener, a binder, and other materials. The same electrical conductor, thickener, binder, and other materials as the cathode active material layers 12 can be used (those capable of being used in the cathode active material layers 12).

The anodes 20 described above are formed by mixing the anode active material, the electrical conductor, the thickener, and the binder, adding a suitable solvent to create a pasty anode mixture, coating the surface of the anode current collector 21 with the mixture, drying the coating, and compressing the result to increase the electrode density as necessary, for example.

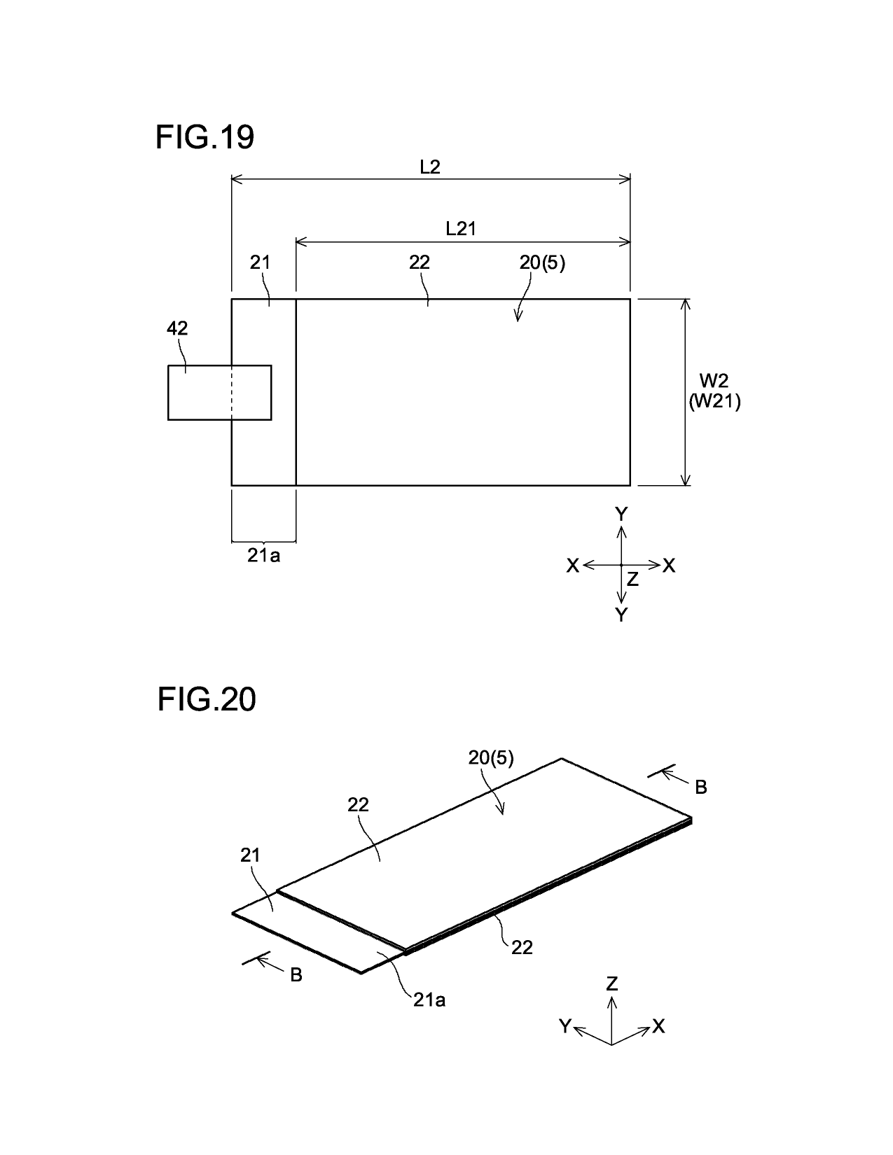

Each of the anodes 20 described above, viewed in plan fashion, has a substantially rectangular shape as shown in FIG. 19, and is formed to substantially the same size (planar area) as the cathodes 10 (see FIGS. 8 and 9). Specifically, in the first embodiment, each of the anodes 20 described above has a width W2 in the Y direction equal to the width W1 of the cathodes 10 (see FIG. 8) at approximately 100 mm, for example, and a length L2 in the X direction equal to the length L1 of the cathodes 10 (see FIG. 8) at approximately 150 mm, for example. The coated region (formed region) of the anode active material layer 22 has a width W21 in the Y direction equal to the width W2 of the anode 20 at approximately 100 mm, for example, and a length L21 in the X direction of approximately 135 mm, for example.

Each of the anodes 20 described above, similar to the cathodes 10, has a current collector exposed part 21a at one end in the X direction, in which the anode active material layer 22 is not formed and the surface of the anode current collector 21 is exposed, as shown in FIGS. 18 through 20. A tab electrode 42 for extracting electric current to the exterior is electrically connected to the current collector exposed part 21a. The tab electrode 42 is formed into a shape approximately 30 mm in width and approximately 70 mm in length, for example, similar to the tab electrode 41 described above (see FIG. 8).

The separators 30 (see FIGS. 1 through 3) constituting the electrode group 50 can be appropriately selected from: electrically insulating synthetic resin fibers, glass fibers, natural fibers, or other nonwoven fabrics; woven fabrics; microporous films; or the like. Of these, polyethylene, polypropylene, polyester, aramid-based resins, cellulose-based resins, or another nonwoven fabrics; and microporous films are preferable in terms of their consistency of quality and other characteristics. Particularly preferable are nonwoven fabrics composed of aramid-based resins, polyester-based resins, or cellulose-based resins; and microporous films.

The separators 30 preferably have a melting point of 200° C. or less so that when heat is generated in the lithium ion secondary cell by internal short circuiting, the holes of the separators 30 are closed off and ionic conduction is blocked; and more preferably have a higher melting point than the resin layer 13 of the cathode current collector 11. For example, the separators 30 are preferably configured so that the thermal shrinkage rate at 120° C. is less than that of the resin layer 13 of the cathode current collector 11. The separators 30 are also preferably configured from a material whose thermal shrinkage rate is 1.0% or less at temperatures equal to or less than the heat distortion temperature of the resin layer 13 of the cathode current collector 11. Furthermore, the separators 30 are preferably configured from a porous film of an aramid-based resin, a polyester-based resin, a cellulose-based resin, or the like, whose thermal shrinkage rate at 180° C. is 1.0% or less.

The thickness of the separators 30 is not particularly limited, but the thickness is preferably capable of keeping in the necessary amount of electrolytic solution, and is also preferably capable of preventing short circuiting of the cathodes 10 and anodes 20. Specifically, the separators 30 can have a thickness of 0.02 mm (20 μum) to 0.1 mm (100 μm), for example. The thickness of the separators 30 is preferably about 0.01 to 1 mm, and more preferably about 0.02 to 0.05 mm. The material constituting the separators 30 preferably has an air permeability per unit surface area (1 cm²) of about 0.1 sec/cm³ to 500 sec/cm³ because a low cell internal resistance can be maintained and a strength sufficient to prevent cell internal short circuiting can be ensured.

For the separators as well, the terms “heat distortion temperature” and “thermal shrinkage rate” mean values obtained by the same methods as the resin layer (the resin film) described above. Heating is performed at 120° C. when the thermal shrinkage rate at 120° C. is being measured, and heating is performed at 180° C. when the thermal shrinkage rate at 180° C. is being measured.

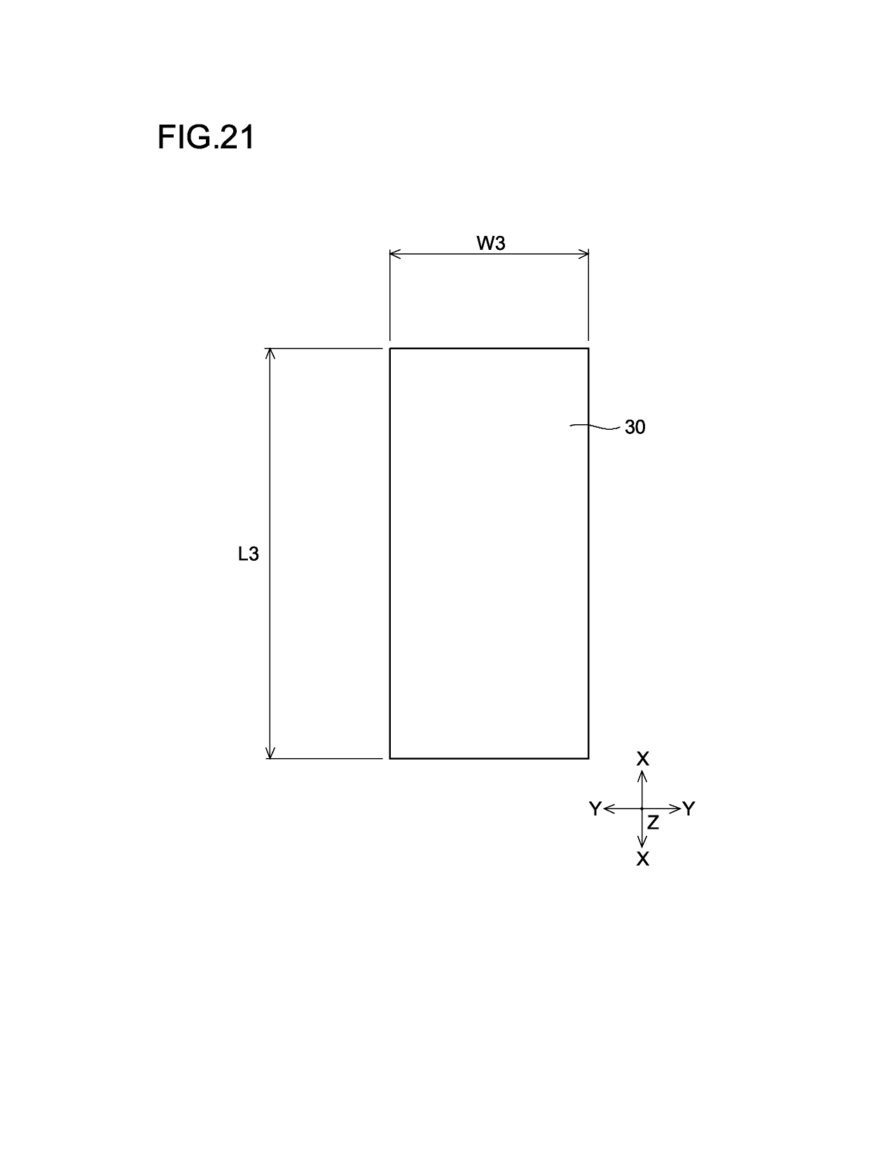

The separators 30 described above have a shape larger than the coated regions (the formed regions) of the cathode active material layers 12 and the coated regions (the formed regions) of the anode active material layers 22. Specifically, each of the separators 30 is formed into a substantially rectangular shape, the width W3 in the Y direction being approximately 115 mm, for example, and the length L3 in the X direction being approximately 160 mm, for example, as shown in FIG. 21.

The cathodes 10 and the anodes 20 described above are placed so that the current collector exposed parts 11a of the cathodes 10 and the current collector exposed parts 21a of the anodes 20 are positioned on opposite sides from each other, and are stacked with the separators 30 interposed between the cathodes and anodes, as shown in FIGS. 1 through 3.

In the first embodiment, through-members 80 passing through the porous-structured cathode current collectors 11 in the thickness direction are provided (mounted) in the current collector exposed parts 11a of the stacked cathodes 10, as shown in FIGS. 1, 2, and 4. The through-members 80 are configured from an electrically conductive material, and by being passed through the through-holes 11b of the cathode current collectors 11, the through-members 80 pass consecutively through all of the stacked cathodes 10 (electrodes 5 of the same polarity).

Each of the through-members 80 described above is configured including a columnar shaft 81 and a head 82 provided to one end of the shaft 81 and having a somewhat larger diameter. After the through-members 80 have been inserted into the through-holes 11b of the cathode current collector 11 as shown in FIGS. 6 and 11, the other ends of the shafts 81 (the ends on the sides opposite the heads 82) are crimped, thereby fixing the stacked cathodes 10 together.

The through-holes 11b of the cathode current collectors 11 are formed to have about the same diameters as the shafts 81 of the through-members 80, as shown in FIG. 13. The surfaces (outer surfaces) of the shafts 81 of the through-members 80 are configured so as to be in firm contact (electrically in contact) with the inside surfaces of the through-holes 11b due to the through-members 80 being inserted into the through-holes 11b. The electrically conductive layer 14 on one side of the resin layer 13 in each of the cathode current collectors 11 and the electrically conductive layer 14 on the other side are thereby electrically connected to each other via the through-members 80, and all of the stacked cathodes 10 are electrically connected to each other due to the through-members 80 being passed consecutively through all of the cathodes 10.

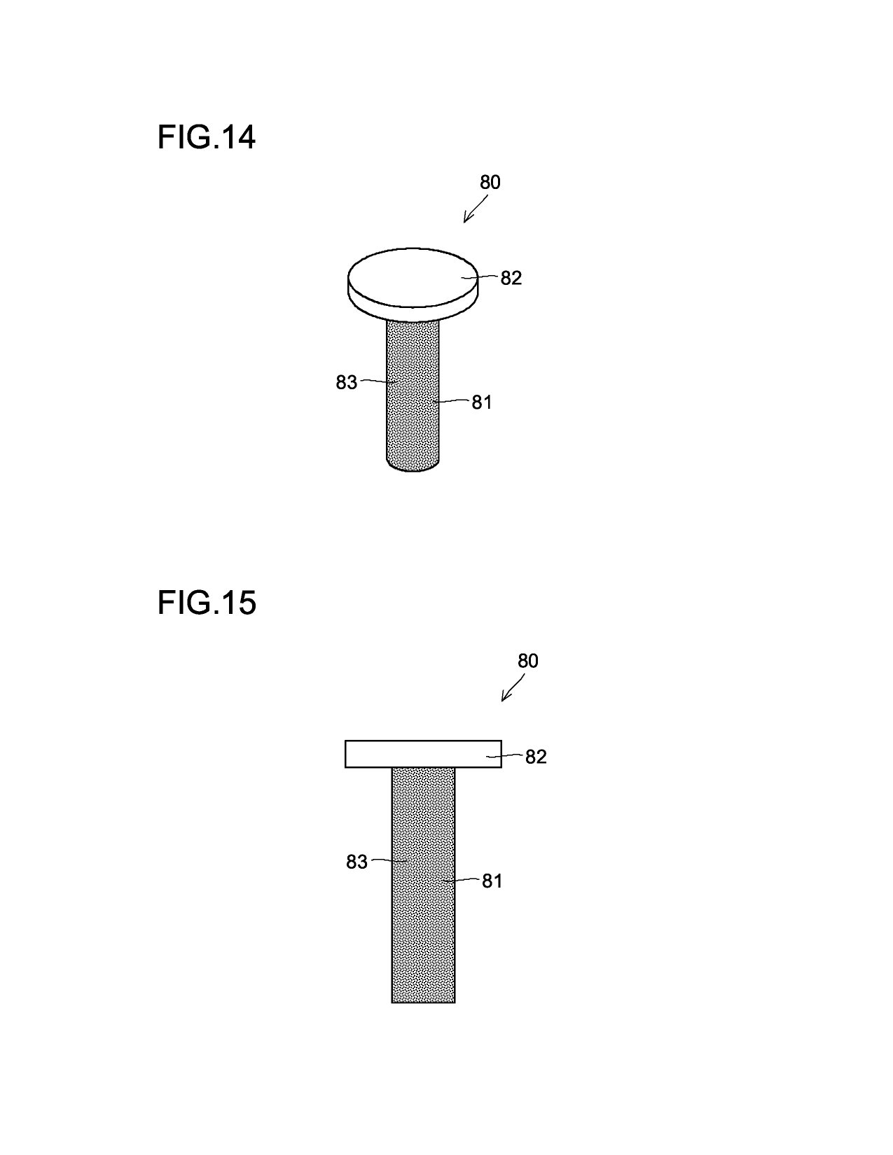

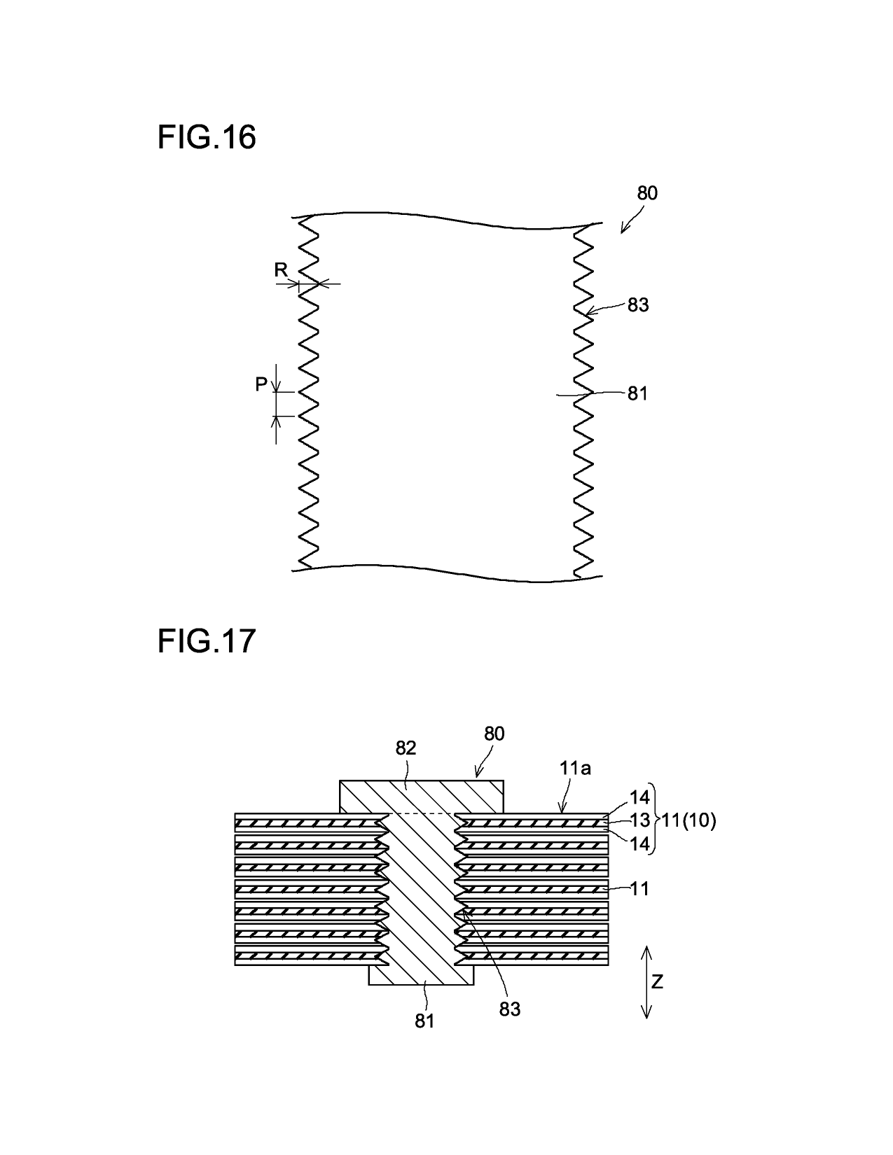

In the first embodiment, asperities 83 (hatched region) are provided in the surface of each of the through-members 80 (the shafts 81) as shown in FIGS. 14 and 15. These asperities 83 are formed in virtually the entire surface of the through-member 80 (the shaft 81) by filing, etching, casting, or the like. The height R of the asperities 83 (the height R of the projections (convex portions)) is preferably in a range of 0.1 μm to 5 mm, as shown in FIG. 16. The shape of the projections (convex portions) of the asperities 83 is not particularly limited, and may be a trapezoidal shape, a three-sided pyramid shape, a semicylindrical shape (substantially semi-elliptical shape), or another shape. The asperities 83 described above as shown in FIG. 16 may be provided at a predetermined pitch P relative to the through direction of the through-members 80 (the direction in which they pass through the stacked cathode current collectors 11 (the Z direction)).

Due to the through-members 80 described above having asperities 83 in their surfaces being inserted into the through-holes 11b as shown in FIG. 17, the through-members 80 and the electrically conductive layers 14 of the cathode current collectors 11 come in contact, and the contact surface area thereof increases.

Furthermore, the through-members 80 also have a function as fastening members for fixing stacked electrodes (cathodes 10) together, as described above. Due to the stacked electrodes (cathodes 10) being fixed by the through-members 80, part of the cathodes 10 (the current collector exposed parts 11a) are in a state of being tightly bonded together.

The through-members 80 are preferably configured from aluminum or an aluminum alloy in terms of electrical conductivity, oxidation resistance, and other characteristics. The through-members 80 may be configured from a material other than aluminum or an aluminum alloy, e.g., titanium, stainless steel, nickel, or other metal materials; alloys thereof; or the like.

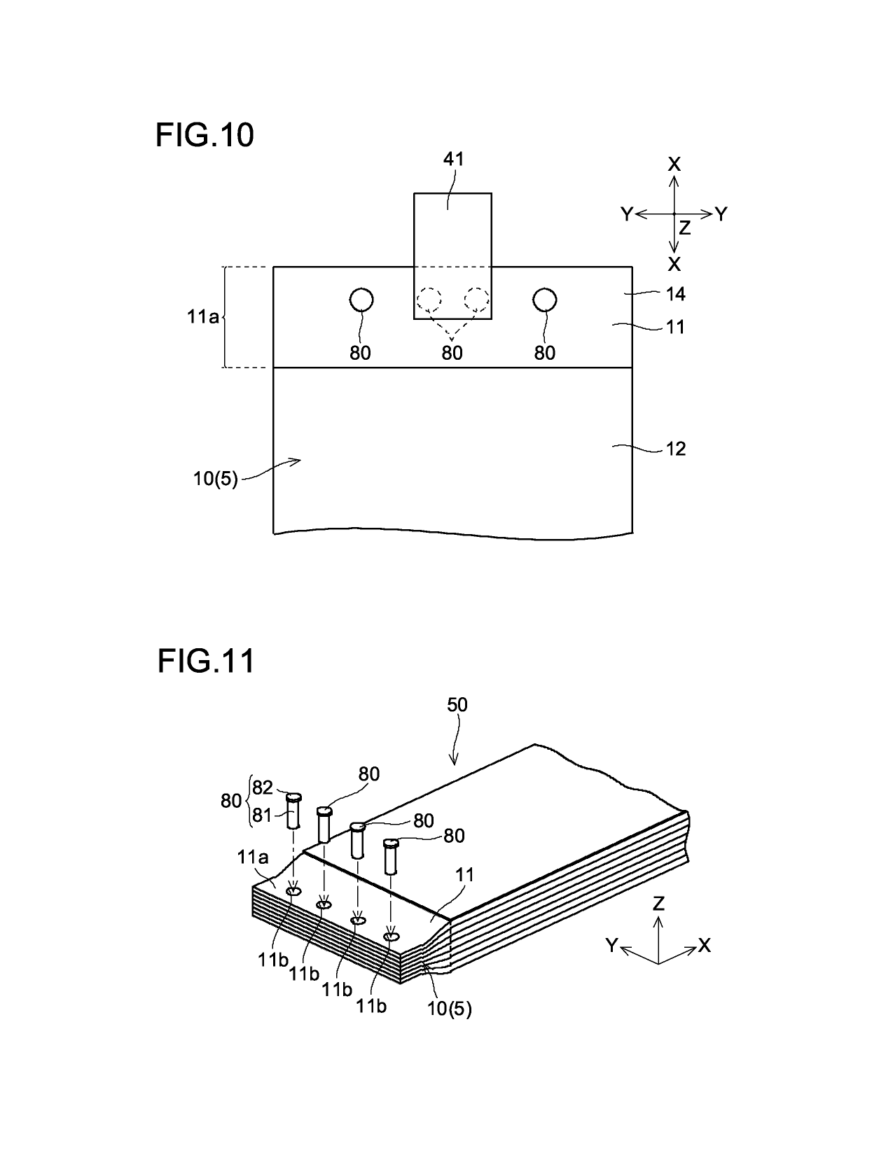

The through-members 80 are preferably provided to a plurality of locations in each of the current collector exposed parts 11a of the cathode current collectors 11, as shown in FIGS. 10 through 12. Due to the through-members 80 being provided (passed through) to a plurality of locations in the current collector exposed parts 11a in this manner, electric conduction between the electrodes (between the cathodes) improves because contact resistance between the cathodes decreases.

Among the cathodes 10 of the electrode group 50 in a state fixed together by the through-members 80 as described above, the tab electrode 41 is fixed by welding to the outermost cathode 10 (the electrically conductive layer 14 of the cathode current collector 11). The tab electrode 41 need not be the outermost layer and may be fixed by welding to a cathode 10 in an intermediate layers. The tab electrode 41 is fixed by welding to the region where the through-members 80 are provided. Specifically, the tab electrode 41 described above is fixed by welding so as to cover the heads 82 of the through-members 80 (disposed so as to overlap the through-members 80) in the substantially central parts (welded region M (see FIG. 1)) in the width direction (Y direction) of the cathode current collector 11 (the cathode 10), as shown in FIGS. 4, 10, and 12. Thereby, all of the stacked cathodes 10 (all of the electrically conductive layers 14) are in a state of being electrically connected with the tab electrode 41. At this time, the tab electrode 41 is preferably welded with the through-members 80 as well.

The plurality of anodes 20 are stacked so that the current collector exposed parts 21a line up, similar to the cathodes 10, as shown in FIGS. 1 through 3. The above-described tab electrode 42 is then fixed by welding to the outermost anode 20 (the anode current collector 21). Similar to the case of the cathode, the tab electrode 42 need not be the outermost layer and may be fixed by welding to an anode 20 in an intermediate layer. All of the stacked anodes 20 are thereby in a state of being fixed by welding to the tab electrode 42 and electrically connected with the tab electrode 42. The tab electrode 42 described above is fixed by welding to the substantially central part in the width direction (Y direction) of the anode current collector 21 (the anode 20).

The welding of the tab electrodes 41 and 42 is preferably ultrasonic welding, but may also be something other than ultrasonic welding, e.g., laser welding, resistance welding, spot welding, or the like may be used. When the tab electrode 41 is welded to cathode current collector 11 sandwiching the resin layer 13, laser welding, resistance welding, spot welding, and other means of bonding by adding heat have a risk of dissolving the resin layer 13. Therefore, ultrasonic welding which does not add heat is preferably used to weld the tab electrode 41 described above.

The tab electrode 41 connected to the cathode 10 is preferably configured from aluminum, and the tab electrode 42 connected to the anode 20 is preferably configured from copper. The tab electrodes 41 and 42 preferably use the same material as the current collectors, but may use a different material. Furthermore, the tab electrode 41 connected to the cathode 10 and the tab electrode 42 connected to the anode 20 may be either the same material or different materials. The tab electrodes 41 and 42 are preferably welded to the substantially central parts in the width direction of the cathode current collector 11 and the anode current collector 21 as described above, but may also be fixed by welding to regions other than the central parts.

The nonaqueous electrolytic solution enclosed along with the electrode group 50 in the external container 100 (see FIG. 2) is not particularly limited, but possible examples of the solvent include: ethylene carbonate (EC), propylene carbonate, butylene carbonate, diethyl carbonate (DEC), dimethyl carbonate, methylethyl carbonate, γ-butyrolactone, and other esters; tetrahydrofuran, 2-methyl tetrahydrofuran, dioxane, dioxolane, diethyl ester, dimethoxyethane, diethoxyethane, methoxyethoxyethane, and other ethers; dimethyl sulfoxide, sulfolane, methyl sulfolane, acetonitrile, methyl formate, methyl acetate, and other polar solvents; and the like. These solvents may be used singly, or two or more solvents may be mixed and used as a mixed solvent.

The nonaqueous electrolytic solution may include an electrolytic supporting salt. Possible examples of the electrolytic supporting salt include LiClO₄, LiBF₄ (lithium borofluoride), LiPF₆ (lithium hexafluorophosphate), LiCF₃SO₃ (lithium trifluoromethanesulfonate), LiF (lithium fluoride), LiCL (lithium chloride), LiBr (lithium bromide), LiI (lithium iodide), LiAlCl₄ (lithium aluminate tetrachloride), and other lithium salts. These may be used singly, or mixtures of two or more may be used.

The concentration of the electrolytic supporting salt is not particularly limited, but is preferably 0.5 to 2.5 mol/L, and more preferably 1.0 to 2.2 mol/L. When the concentration of the electrolytic supporting salt is less than 0.5 mol/L, there is a risk that the concentration of the carrier that carries an electrical charge in the nonaqueous electrolytic solution will decrease and the resistance of the nonaqueous electrolytic solution will increase. When the concentration of the electrolytic supporting salt is higher than 2.5 mol/L, there is a risk that the degree of disassociation of the salt itself will decrease and the carrier concentration in the nonaqueous electrolytic solution will not increase.

The external container 100 enclosing the electrode group 50 is a large, flat, square container, configured including an external canister 60 for accommodating the electrode group 50 and the like, and a sealing plate 70 for sealing up the external canister 60, as shown in FIGS. 2 and 5. The sealing plate 70 is also mounted on the external canister 60 accommodating the electrode group 50 by laser welding, for example.

The external canister 60 is formed by performing a deep drawing process or the like on a metal plate, for example, and is formed into a substantial box shape having a floor surface 61 and side walls 62. An opening 63 for inserting the electrode group 50 is also provided in one end of the external canister 60 (on the side opposite the floor surface 61), as shown in FIG. 2. The external canister 60 is formed into a size capable of accommodating the electrode group 50 so that the electrode surface thereof faces the floor surface 61.

In the external canister 60 described above, an electrode terminal 64 (e.g., a cathode terminal) is formed in a side wall 62 on one side in the X direction (a short side), and an electrode terminal 64 (e.g., an anode terminal) is formed in a side wall 62 on the other side in the X direction (a short side), as shown in FIGS. 2 and 5. A liquid inlet 65 for pouring in the nonaqueous electrolytic solution is formed in a side wall 62 of the external canister 60. This liquid inlet 65 is formed to a size of φ2 mm, for example. In proximity to the liquid inlet 65, a safety valve 66 for releasing the cell internal pressure is formed.

Furthermore, a bent part 67 is provided around the circumferential edge of the opening 63 of the external canister 60, and the sealing plate 70 is fixed by welding to the bent part 67.

The external canister 60 and the sealing plate 70 can be formed using a metal plate of iron, stainless steel, aluminum, or the like; or a steel plate of nickel plated over iron, for example. Iron is an inexpensive material and is therefore preferable in terms of cost, but to ensure long-term reliability, it is more preferable to use a metal plate composed of stainless steel, aluminum, or the like, or a steel plate of nickel plated over iron. The thickness of the metal plate can be approximately 0.4 mm to 1.2 mm, for example (approximately 1.0 mm, for example).

The electrode group 50 described above is accommodated in the external canister 60 so that the cathodes 10 and anodes 20 face the floor surface 61 of the external canister 60. In the accommodated electrode group 50, the current collector exposed parts 11a of the cathodes 10 and the current collector exposed parts 21a of the anodes 20 are electrically connected with the electrode terminal 64 of the external canister 60 via the tab electrodes 41 and 42.

The nonaqueous electrolytic solution is depressurized and poured in, for example, through the liquid inlet 65 after the opening 63 of the external canister 60 has been sealed by the sealing plate 70. After a metal ball (not shown) of virtually the same diameter as the liquid inlet 65 or a metal plate (not shown) slightly larger than the liquid inlet 65 has been placed in the liquid inlet 65, the liquid inlet 65 is sealed by resistance welding, laser welding, or the like.

In the lithium ion secondary cell according to the first embodiment, providing the through-members 80 which pass through the cathode current collector 11 in the thickness direction as described above enables the electrically conductive layer 14 on one side and the electrically conductive layer 14 on the other side of the resin layer 13 in the cathode current collector 11 to be electrically connected via the through-members 80. Therefore, due to the through-members 80 being consecutively passed through all of the plurality of stacked cathodes 10 (cathode current collectors 11), electrical conduction among a plurality of stacked electrodes can be established even when current collectors (cathode current collectors 11) having a multi-layered structure are used. The tab electrode 41 can thereby be electrically connected with all of the plurality of stacked electrodes (cathodes 10). Consequently, decreases in cell performance can be suppressed, and the lithium ion secondary cell can be put into practical application with maximum performance.

In the first embodiment, the contact surface area between the through-members 80 and the cathodes 10 (the electrically conductive layers 14 of the cathode current collectors 11) can be increased by providing the asperities 83 in the surfaces of the through-members 80, and contact resistance between the through-members 80 and the electrodes 5 (the cathodes 10) can therefore be reduced. Therefore, contact resistance can be reduced in electrodes other than the electrode in contact with the tab electrode 41. Therefore, electrical conduction can be established among the plurality of stacked cathodes 10 (cathode current collectors 11) via the through-members 80, and the tab electrode 41 can therefore be electrically connected with the plurality of stacked cathodes 10 (cathode current collectors 11). As a result, decreases in cell performance can be further suppressed.

Furthermore, in the first embodiment, when the height of the asperities 83 is in a range of 0.1 μm to 5 mm, the contact surface area between the through-members 80 and the cathodes 10 (the electrically conductive layers 14 of the cathode current collectors 11) can be easily increased.

In the first embodiment, due to the through-members 80 described above being provided, when the tab electrode 41 is connected to an electrode (a cathode 10) by ultrasonic welding, for example, the contact resistance between the tab electrode 41 and the electrode (the cathode 10) and the contact resistance between electrodes can be reduced. It is thereby possible to connect the tab electrode 41 with strong electrical conduction to the electrode (the cathode 10). Due to the tab electrode 41 being strongly connected with electrical conduction to the electrode (the cathode 10), it is possible to suppress decreases in cell capacity originating from increases in contact resistance.

In the first embodiment, due to current collectors having a multi-layered structure being used in the cathode current collectors 11 as described above, when an abnormal amount of heat is generated in an overcharged state, a high-temperature state, or the like, for example, the resin layers 13 of the current collectors 11 melt and the electrodes (cathodes 10) fail, and electric current is therefore cut off. Temperature increases in the cell interior can thereby be suppressed, and ignition and other abnormal states can therefore be prevented.

In the first embodiment, due to the through-members 80 functioning as fastening members being passed through the plurality of stacked cathodes 10 (cathode current collectors 11), parts of the cathode current collectors 11 can be tightly bonded together. Therefore, when a plurality of the cathodes 10 are stacked, the contact resistance of the cathodes 10 (cathode current collectors 11) can be reduced, and the tab electrode 41 and the cathode 10 can be strongly connected with electrical conduction, as can cathodes 10 to each other. Decreases in cell performance can thereby be suppressed more effectively.

Due to the tab electrode 41 described above being fixed by welding to the region where the through-members 80 are provided, electrical conduction between the tab electrode 41 and the cathode 10 can more readily be established.

In the first embodiment, due to through-holes 11b through which the through-members 80 are inserted being formed in advance in the cathode current collectors 11, the through-members 80 can easily be passed through the current collectors in the thickness direction. The electrically conductive layer 14 on one side and the electrically conductive layer 14 on the other side of the resin layer 13 in each of the cathode current collectors 11 can thereby be easily electrically connected.

In the first embodiment, due to the resin layers 13 of the cathode current collectors 11 being configured from a thermoplastic resin whose thermal shrinkage rate at 120° C. is 1.5% or greater in any planar direction (e.g., either the longitudinal direction or the transverse direction), when an abnormal amount of heat is generated in an overcharged state, a high-temperature state, or the like, for example, the electrodes can be made to readily fail. The ignition and other abnormal states can thereby be effectively prevented, and the safety of the lithium ion secondary cell can therefore be effectively improved.

When the resin layers 13 of the cathode current collectors 11 are configured from a polyolefin resin, polyvinyl chloride, or a composite material of the two, the safety of the lithium ion secondary cell can easily be improved.

In the first embodiment, due to the separators 30 being configured so that the thermal shrinkage rate at 120° C. is less than that of the resin layers 13 of the cathode current collectors 11, the resin layers 13 constituting the current collectors of the cathodes 10 can be fusion-cut before the shutdown function of the separators 30 activates. The electric current can thereby be cut off in two stages by the electric current cutoff effect of the resin layers 13 and the separators 30, and the safety of the lithium ion secondary cell can therefore be further improved.

When the thermal shrinkage rate of the above-described separators 30 at 180° C. is 1.0% or less, the occurrence of internal short circuiting originating from thermal shrinkage of the separators 30 (internal short circuiting of the cell occurring in the ends of the electrodes) can be suppressed in the case that an abnormal amount of heat is generated in an overcharged state or a high-temperature state, and the occurrence of sudden temperature increases can therefore be suppressed. Therefore, it is possible to suppress the occurrence of internal short circuiting originating from the thermal shrinkage of the separators 30 when heat is generated in the cell interior (internal short circuiting of the cell occurring in the electrode ends), and the occurrence of sudden temperature increases can therefore be suppressed. As a result, the safety of the lithium ion secondary cell can be further improved. Specifically, with such a configuration, melting and fluidization of the separators 30 can be suppressed even at a temperature of 180° C., and it is therefore possible to suppress the inconvenience of the holes of the separators 30 increasing in size because of melting and fluidization. Therefore, when the cell interior reaches 180° C., even if the electrode (the cathode 10) failure does not occur for some reason, it is possible to suppress the inconvenience of larger areas of short circuiting in the cathodes and anodes originating from the increase in size of the holes of the separators 30.

### EXAMPLE 1

In Example 1, 100 parts by weight of LiCoO₂ was used as a cathode active material, 10 parts by weight of acetylene black was used as an electrical conductor, 10 parts by weight of polyvinylidene fluoride was used as the binder, and N-methyl-2-pyrrolidone (NMP) was used as the solvent to produce a paste for forming an cathode active material layer. A cathode current collector was produced by forming aluminum vapor deposition layers (electrically conductive layers) 1 μm in thickness on both sides of a propylene film (resin film) having a thickness of 15 μm. Both sides of the cathode current collector were coated with the paste, and after sufficient drying, the result was pressed with a hydraulic press, thereby obtaining a cathode. The weight of the active material per unit surface area in the cathode was 40 mg/cm².

Next, 100 parts by weight of natural graphite (average grain size 15 μm, average surface-to-surface gap d₀₀₂=0.3357 nm, BET specific surface area 3 m²/g) from China was used as the anode active material, 12 parts by weight of PVDF was used as the binder, and NMP was used as the solvent to produce a paste for forming an anode active material layer.

In Example 1, the anode current collector was also configured into a multi-layered structure having electrically conductive layers formed on both sides of the resin layer, similar to the cathode current collector. Specifically, the anode current collector was produced by forming copper vapor deposition layers (electrically conductive layers) 1 μm in thickness on both sides of a propylene film (a resin layer) having a thickness of 15 μm. Both sides of the anode current collector were then coated with the paste described above, and after sufficient drying, an anode was obtained by pressing with a hydraulic press.

In Example 1, a microporous film made of polyethylene having a thickness of 25 μm was used as the separator. Through-holes for inserting the through-members were formed in the regions in the cathode current collector and the anode current collector where the active material layers were not formed (the exposed regions).

Using thirteen cathodes 10, fourteen anodes 20, and twenty-eight separators 30, the cathodes 10 and anodes 20 were alternately stacked with separators 30 in between, thereby configuring an electrode group (stacked body). The state of the electrode group was such that a separator was placed on the outermost side (the outer side of the outermost-layer anode).

Next, after the through-members were inserted through the respective through-holes of the cathodes and anodes, the ends of the through-members were crimped, thereby fixing the stacked electrodes together. Aluminum through-members were used as the through-members on the cathode side, and copper through-members were used as the through-members on the anode side.

Asperities were also provided by filing in the surfaces of the through-members. The diameter of the shaft of each through-member (the through-member core diameter) was φ10 mm. The asperity height was 100 μm and the asperity pitch was 120 μm.

A tab electrode was fixed by ultrasonic welding to both the cathodes and the anodes of the electrode group fixed by the through-members. The tab electrode fixed to the cathodes was made of aluminum, and the tab electrode fixed to the anodes was made of copper. The tab electrodes were also fixed (electrically connected) to the through-members by ultrasonic welding.

The electrode group 50 was then enclosed in the external container and the nonaqueous electrolytic solution was poured in, thereby producing the lithium ion secondary cell according to Example 1.

Upon performing a charge and discharge test using the obtained lithium ion secondary cell, no decrease in cell performance was observed despite the use of a current collector having a multi-layered structure. It was thereby confirmed that the lithium ion secondary cell could be put into practical application with maximum performance.

### Second Embodiment

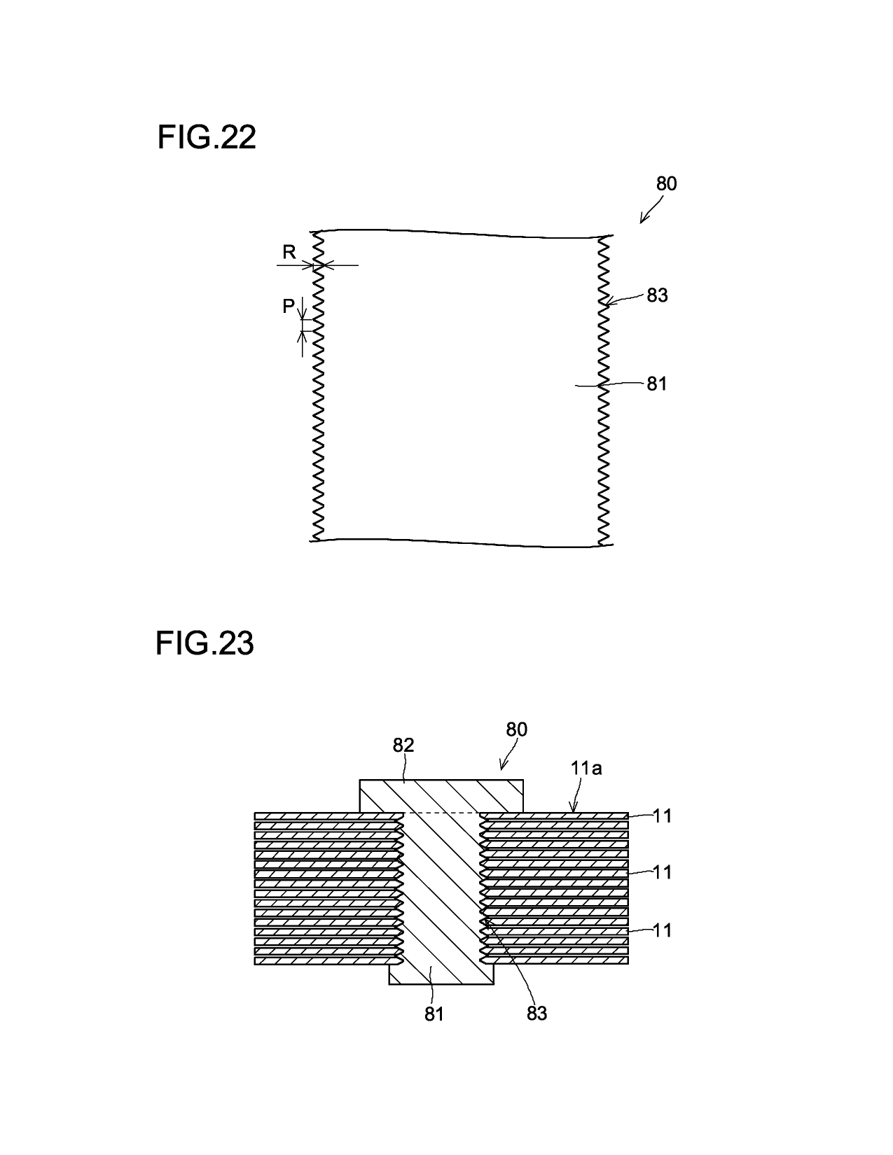

FIG. 22 is a cross-sectional view showing an enlargement of part of a through-member according to the second embodiment of the present invention. FIG. 23 is a cross-sectional view schematically showing a state in which the through-member according to the second embodiment of the present invention has been passed through a stack of cathode current collectors. Next, the lithium ion secondary cell according to the second embodiment of the present invention will be described referring to FIGS. 22 and 23. In these drawings, corresponding configurational elements are given the same symbols and redundant descriptions are appropriately omitted.

In the second embodiment, the asperities 83 of the through-members 80 used are different from the configuration of the first embodiment described above, as shown in FIGS. 22 and 23. Specifically, in the through-members 80 of the second embodiment, the asperities 83 are formed to be smaller than in the first embodiment described above.

The pitch P of the asperities 83 described above is preferably about 0.1 to 2 times the thickness of the current collectors (the cathode current collectors 11). In this case, the pitch P of the asperities 83 is more preferably equal to the thickness of the current collectors (the cathode current collectors 11). With such a configuration, the projections (convex portions) of the asperities 83 are readily disposed between the electrodes (between adjacent cathode current collectors 11). Therefore, due to the projections (convex portions) of the asperities 83 being disposed between the electrodes, the contact surface area between the through-member 80 and the electrodes increases efficiently. The contact resistance between the through-member 80 and the electrodes is thereby effectively reduced.

The configuration and effects of the second embodiment are otherwise identical to those of the first embodiment described above.

### EXAMPLE 2

Example 2 had the same configuration as Example 1 described above except for the through-member having different asperities than Example 1 described above. Specifically, in Example 2, the pitch of the asperities of the through-member is matched to the thickness of the current collectors.

More specifically, the diameter of the shaft of the through-member (the through-member core diameter) was φ10 mm and the height of the asperities was 20 μm. The pitch of the asperities was 50 μm. The thickness of the current collectors used was 50 μm, and the pitch of the asperities of the through-member was thereby matched to the thickness of the current collectors. It was thereby possible to further increase the contact surface area between the through-member and the current collectors, and also to achieve lower resistance.

The material of the through-members on the cathode side is aluminum, and the material of the through-members on the anode side is copper.

### Third Embodiment

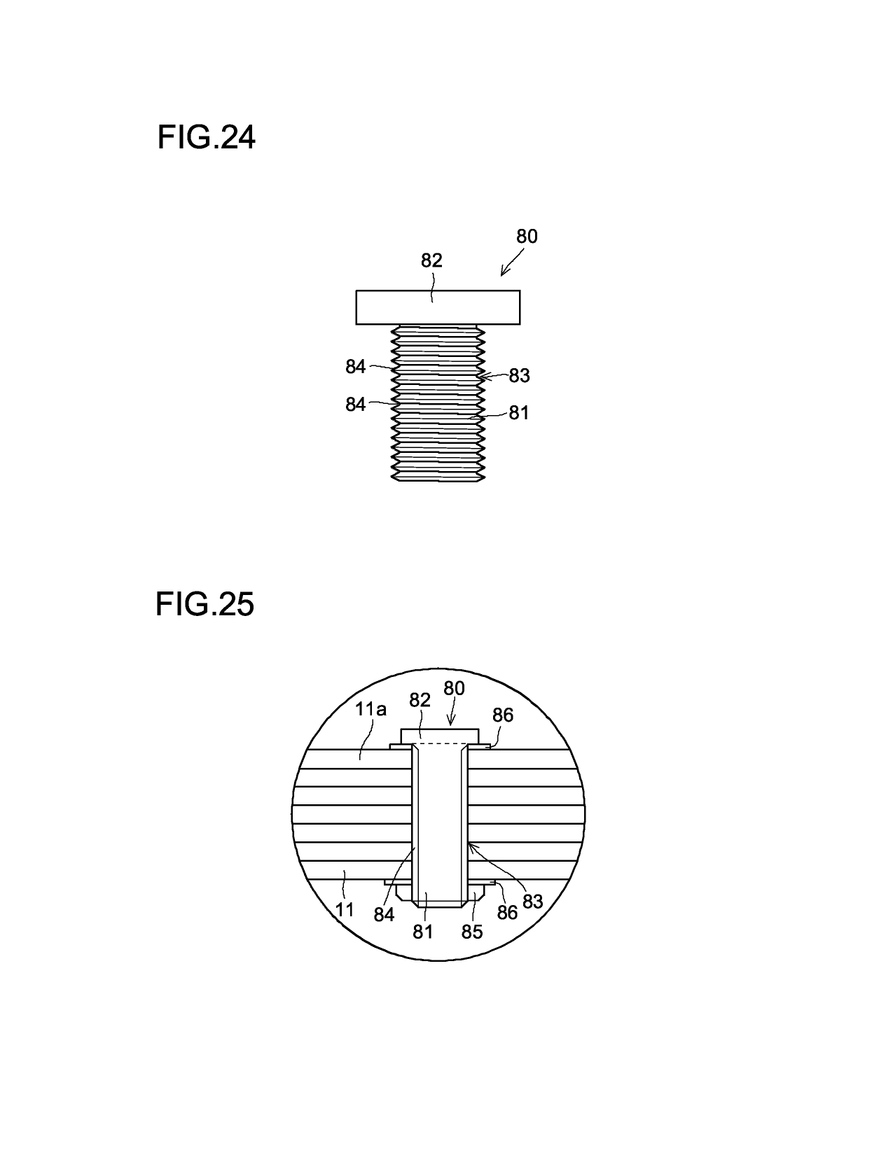

FIG. 24 is a cross-sectional view of a through-member according to the third embodiment of the present invention. FIG. 25 is a cross-sectional view schematically showing a state in which a through-member according to the third embodiment of the present invention has been passed through a stack of cathode current collectors. Next, the lithium ion secondary cell according to the third embodiment of the present invention will be described referring to FIGS. 7, 24 and 25. In these drawings, corresponding configurational elements are given the same symbols and redundant descriptions are appropriately omitted.

In the third embodiment, a thread groove 84 is provided in the surface of the through-member 80 (the shaft 81) as shown in FIG. 24. The asperities 83 are formed in the surface of the through-member 80 by the formation of the thread groove 84.

The pitch of the thread groove 84 is preferably about 0.1 to 2 times the thickness of the current collectors (the cathode current collectors 11 (see FIG. 7)), and is more preferably equal to the thickness of the current collectors (the cathode current collectors 11 (see FIG. 7)), as shown in the second embodiment described above.

Thus, providing the thread groove 84 in the through-member 80 allows the through-member 80 to be fastened, and the screw peaks (convex portions of the asperities 83) can be placed in between electrodes (in between adjacent cathode current collectors 11). The contact surface area between the through-member 80 and the electrodes can thereby be more efficiently increased.

In this case, the stacked electrodes (cathodes 10) can be fixed together by fastening the through-member 80 with a nut 85, as shown in FIG. 25. At this time, the through-member 80 may be fastened via a washer 86 or the like as necessary.

The configuration and effects of the third embodiment are otherwise identical to those of the first and second embodiments described above.

### Fourth Embodiment

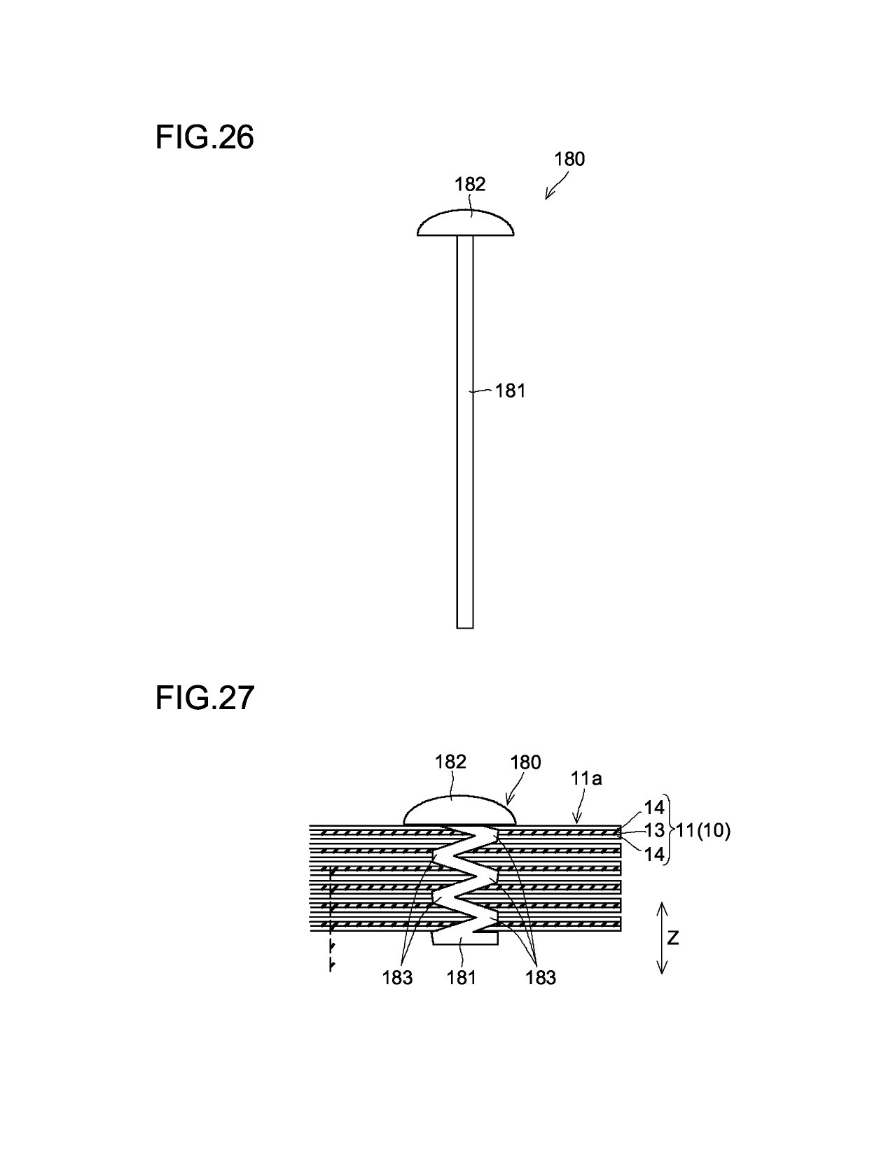

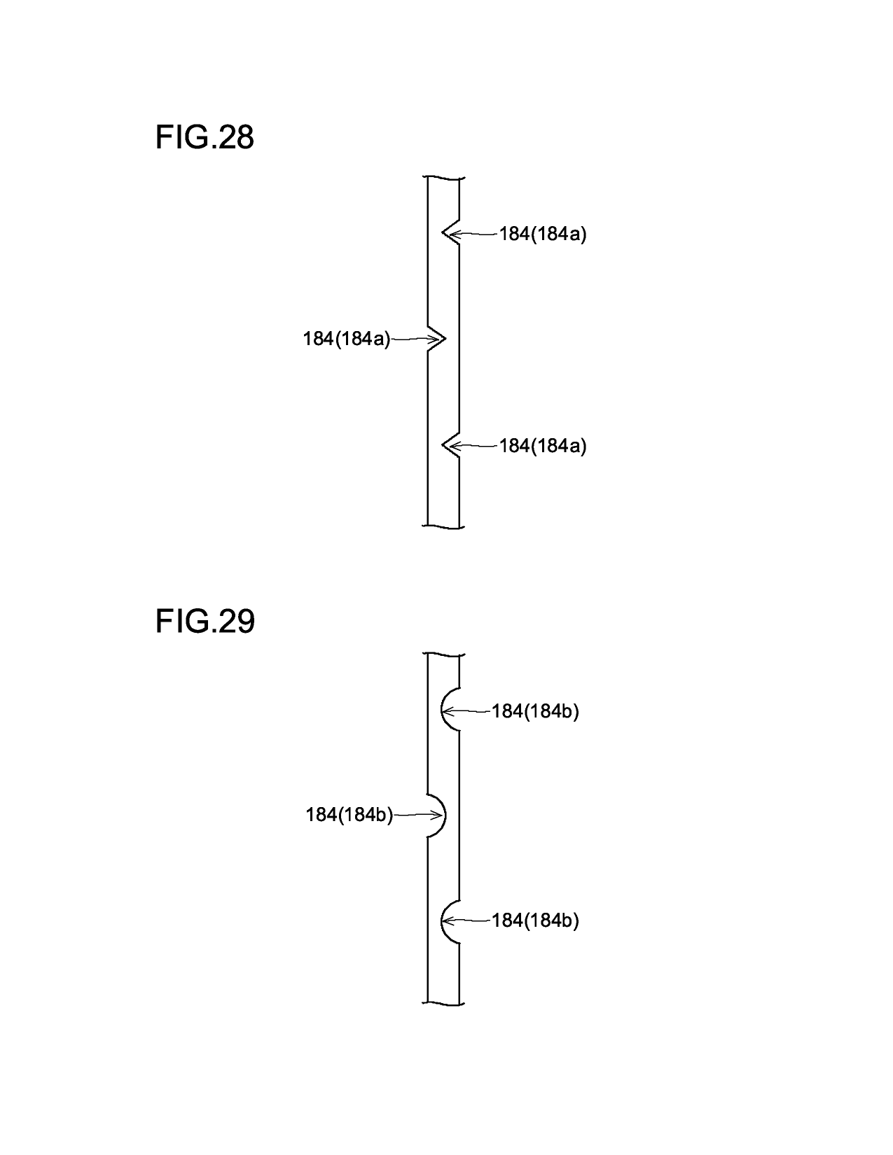

FIG. 26 is a side view of a through-member according to the fourth embodiment of the present invention. FIG. 27 is a cross-sectional view schematically showing a state in which the through-member according to the fourth embodiment of the present invention has been passed through a stack of cathode current collectors. FIGS. 28 and 29 are schematic cross-sectional views showing an enlargement of part of the through-member according to the fourth embodiment of the present invention. Next, the lithium ion secondary cell according to the fourth embodiment of the present invention will be described referring to FIGS. 26 through 29. In these drawings, corresponding configurational elements are given the same symbols and redundant descriptions are appropriately omitted.

In the fourth embodiment, unlike the first through third embodiments described above, a through-member 180 is configured so as to deform within the stacked cathodes 10 (cathode current collectors 11), as shown in FIGS. 26 and 27. Specifically, as shown in FIG. 27, the through-member 180 of the fourth embodiment has a shaft 181 and a head 182, and is configured so that the shaft 181 (the portion passing through the current collectors (a through-part 181)) is bent within the stacked cathodes 10 (cathode current collectors 11). This bent portion (a bent part 183 (deformed portion)) (the through-part 181 including the bent part 183) is in a state of contact with the surface of the cathode current collectors 11 (the electrically conductive layers 14).

In the fourth embodiment, bend starting parts 184 where bending begins are formed in the shaft 181 of the through-member 180, as shown in FIG. 28. The bend starting parts 184 are composed of cut-outs 184a formed by cut-out machining in the shaft 181, for example. A plurality of the bend starting parts 184 (the cut-outs 184a) are formed in the shaft 181 so that the shaft 181 bends at desired positions. The bend starting parts 184 may also be configured from concavities 184b formed by slightly (thinly) machining out part of the shaft 181, as shown in FIG. 29, for example.

The through-member 180 according to the fourth embodiment configured in this manner is bent with the bend starting parts 184 as bending points, whereby the bent parts 183 are positioned between mutually adjacent cathodes 10 (cathode current collectors 11) as shown in FIG. 27.

The shaft 181 (through-part 181) of the through-member 180 can be a long, thin, rod shaped substantially as a circle in cross section. Instead of a circle, the shape of the shaft 181 (through-part 181) may be a flat plate (rectangular strip), a rod that is substantially semicylindrical (substantially semi-ellipsoidal) in cross section, a quadrangular prism, a triangular prism, or another shape.

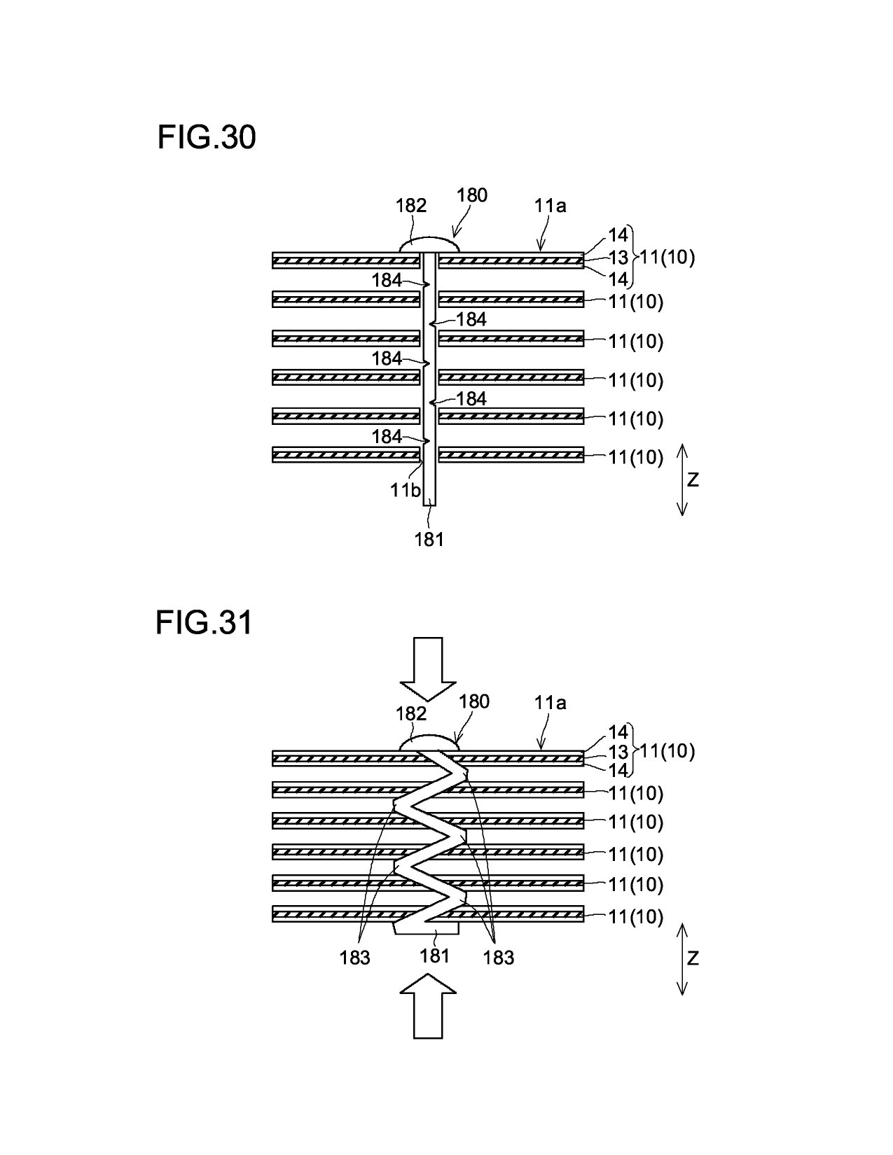

FIGS. 30 and 31 are schematic cross-sectional views showing a method for mounting the through-member according to the fourth embodiment of the present invention. Next, the method for mounting the through-member according to the fourth embodiment will be described referring to FIGS. 27, 30, and 31.

First, the through-member 180 is inserted into the through-holes 11b of the cathode current collectors 11, as shown in FIG. 30. At this time, the gaps in the cathode current collectors 11 are adjusted so that the bending positions (the bend starting parts 184) are positioned between adjacent cathodes 10.

Next, a load (refer to the white arrows) in the through direction (the Z direction) is gradually applied to the through-member 180, as shown in FIG. 31. The through-member 180 thereby bends at the bend starting parts 184, and the bent parts 183 are positioned between mutually adjacent cathodes 10 (cathode current collectors 11).

Thereby, with the bent parts 183 of the through-member 180 in a state of contact with the surfaces of the cathode current collectors 11 (the electrically conductive layers 14), the through-member 180 is mounted in the stacked cathode current collectors 11, as shown in FIG. 27.

The configuration of the fourth embodiment is otherwise identical to the first embodiment described above. Unlike the first through third embodiments described above, the fourth embodiment has a configuration in which asperities are not provided to the surface of the through-member 180.

In the fourth embodiment, the contact surface area between the through-member 180 and the electrodes (the cathode current collectors 11) can be increased by causing the through-member 180 to deform within the stacked cathodes 10 (cathode current collectors 11) and bringing the deformed portions in contact with the surfaces of the cathode current collectors 11 as described above. Therefore, the contact resistance between the through-member 180 and the electrodes (the cathode current collectors 11) can be reduced. Therefore, electrical conduction among the plurality of stacked electrodes (among the cathode current collectors 11) can be established via the through-member 180, and the tab electrodes can be electrically connected with the plurality of stacked electrodes (cathode current collectors 11). As a result, decreases in cell performance can be further suppressed.

In the fourth embodiment, due to the through-member 180 being configured having bent parts 183 that are bent within the stacked electrodes (cathode current collectors 11), the bent portions are in contact with the cathode current collectors 11, and the contact surface area between the through-member 180 and the electrodes (the cathode current collectors 11) can therefore be easily increased.

In the fourth embodiment, the contact surface area between the through-member 180 and the electrodes (the cathode current collectors 11) can be efficiently increased by placing the bent parts 183 of the through-member 180 between mutually adjacent electrodes (cathode current collectors 11). The contact resistance between the through-member 180 and the electrodes (the cathode current collectors 11) can thereby be effectively reduced.

Furthermore, in the fourth embodiment, bend starting parts 184 where bending begins are formed in the through-member 180. Since the through-member 180 bends easily in the bend starting parts 184, providing the bend starting parts 184 to the desired positions makes it possible to bend the through-member 180 at the desired positions. Therefore, the through-member 180 can be bent between the electrodes (between the cathode current collectors 11) by providing the bend starting parts 184 so as to be positioned between mutually adjacent electrodes (cathode current collectors 11). The bent parts 183 of the through-member 180 can thereby be easily positioned between mutually adjacent electrodes (cathode current collectors 11). As a result, the contact surface area between the through-member 180 and the electrodes (the cathode current collectors 11) can be increased more easily.

The effects of the fourth embodiment are otherwise identical to the first embodiment described above.

### EXAMPLE 3

Example 3 had the same configuration as the fourth embodiment described above, except that the material of the through-member was aluminum and the diameter of the shaft (through-part) of the through-member (the through-member core diameter) was φ5 mm.

### Fifth Embodiment

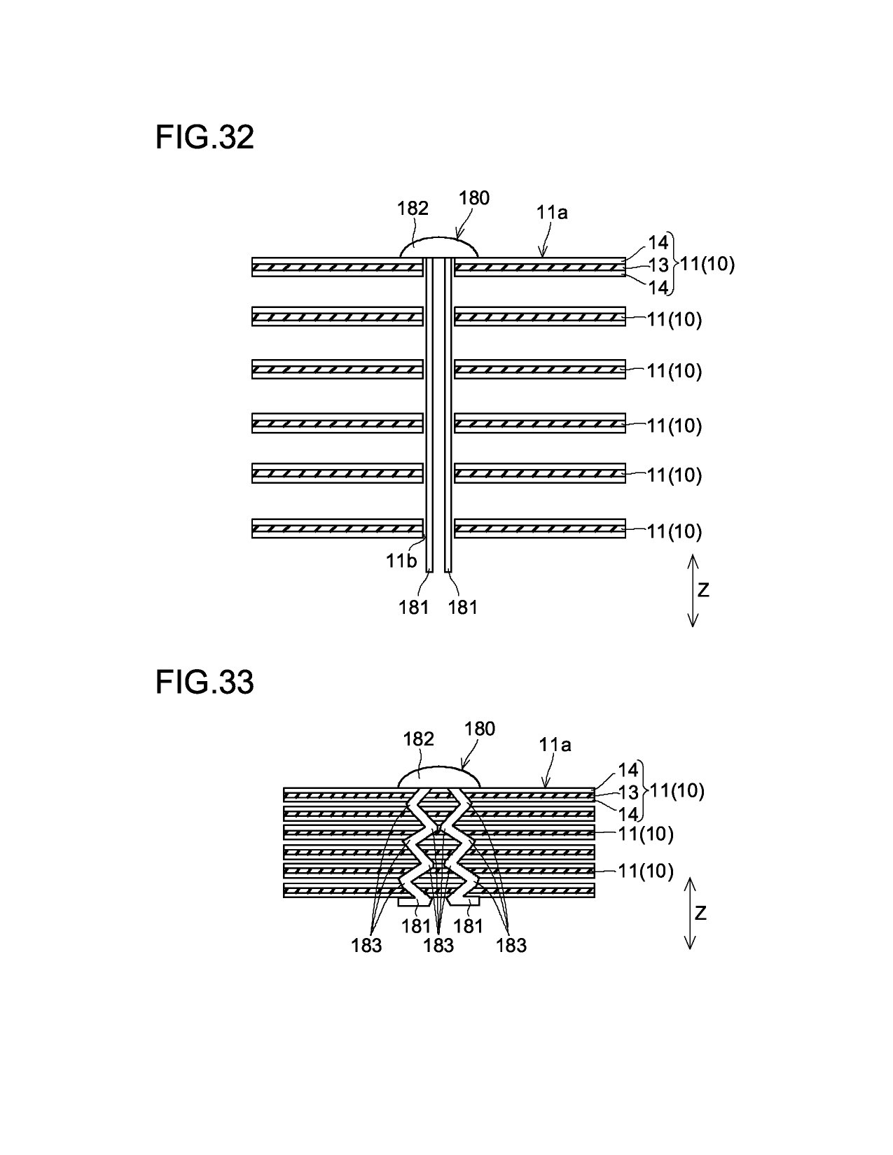

FIG. 32 is a cross-sectional view schematically showing a through-member according to the fifth embodiment of the present invention. FIG. 33 is a cross-sectional view schematically showing a state in which the through-member according to the fifth embodiment of the present invention has been passed through a stack of cathode current collectors. Next, the lithium ion secondary cell according to the fifth embodiment of the present invention will be described referring to FIGS. 28 through 30, FIG. 32, and FIG. 33. In these drawings, corresponding configurational elements are given the same symbols and redundant descriptions are appropriately omitted.

The fifth embodiment has the same configuration as the fourth embodiment described above, except that the through-member 180 has a plurality of portions (through-parts 181) that pass through the current collectors. Specifically, in the fifth embodiment, the portion in the through-member 180 that passes through the stacked electrodes (cathode current collectors 11) is divided. The number of divided through-portions in the through-member 180 (the number of through-member necks) is not particularly limited, but is preferably two to sixteen, for example. FIGS. 32 and 33 show a configuration in which the through-member 180 is divided in two (a configuration having two through-parts 181).

The bend starting parts 184 (see FIGS. 28 through 30) shown in the fourth embodiment described above are also formed in the through-parts 181 of the through-member 180. Similar to the fourth embodiment described above, the through-parts 181 of the through-member 180 are bent within the stacked electrodes (cathode current collectors 11). These bent portions (the bent parts 183 (deformed portions)) are in a state of contact with the surfaces of the cathode current collectors 11 (the electrically conductive layers 14).

The configuration of the fifth embodiment is otherwise identical to the fourth embodiment described above.

In the fifth embodiment, the contact surface area between the through-member 180 and the electrodes (the cathode current collectors 11) can be further increased by providing a plurality of through-parts 181 to the through-member 180 as described above, and the contact resistance between the through-member 180 and the electrodes (the cathode current collectors 11) can therefore be further reduced.

The effects of the fifth embodiment are otherwise identical to the fourth embodiment described above.

### EXAMPLE 4

Example 4 had the same configuration as Example 3 described above, except that the neck of the through-member (the portion that passes through (the through-part) was divided in two. Specifically, in the fourth embodiment, the number of through-parts of the through-member (the number of through-member necks) was two. The material of the through-member was aluminum, similar to Example 3. Unlike Example 3 described above, the diameter of the shaft (through-part) of the through-member (the through-member core diameter) was φ3 mm.

### Sixth Embodiment

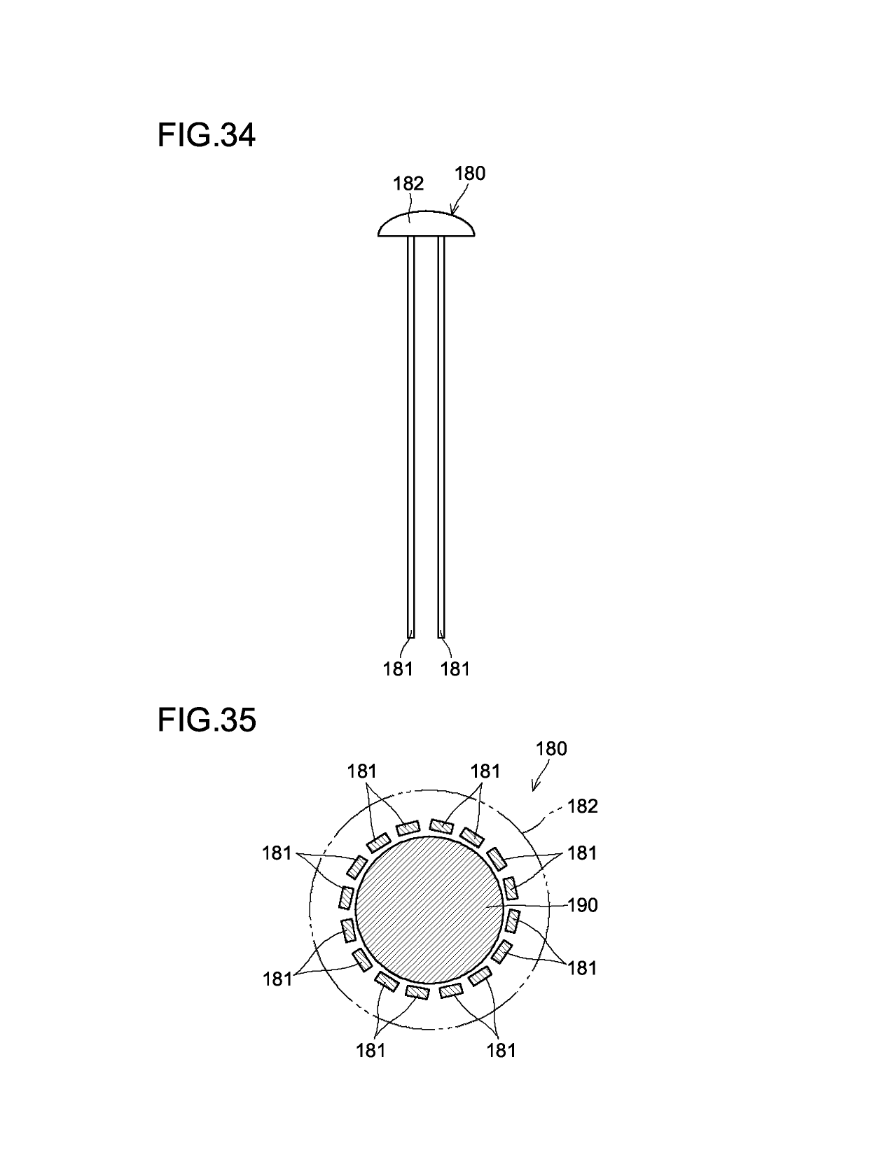

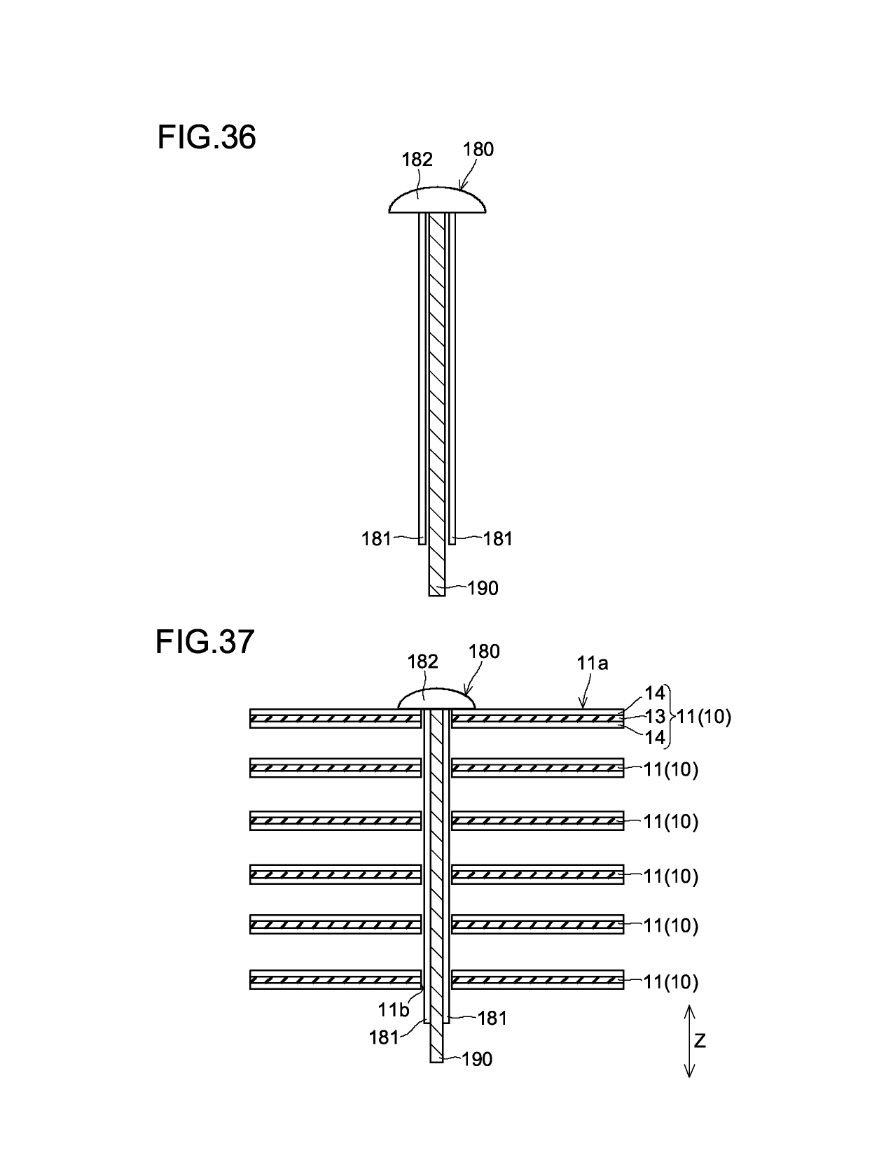

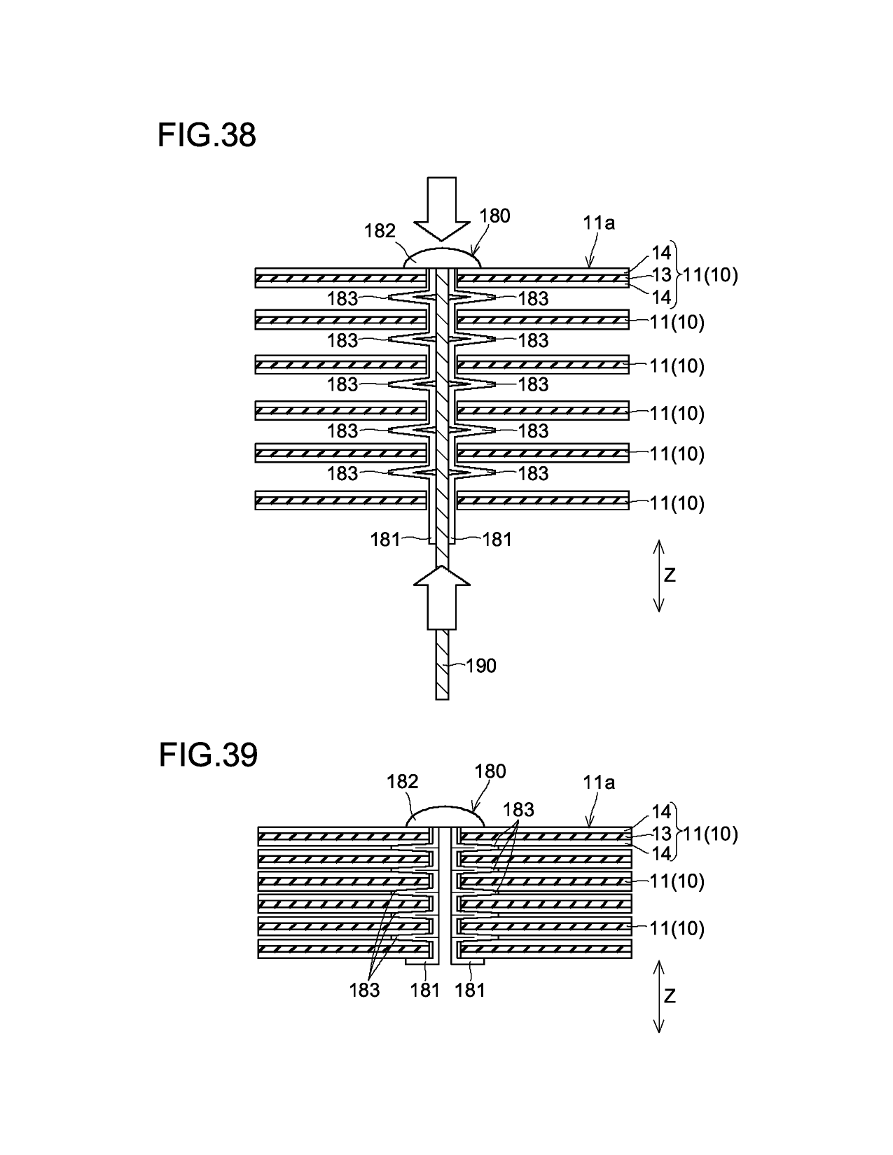

FIG. 34 is a cross-sectional view schematically showing a through-member according to the sixth embodiment of the present invention. FIG. 35 is a schematic plan view of the through-member according to the sixth embodiment of the present invention as seen from the top side. FIG. 36 is a cross-sectional view schematically showing the through-member according to the sixth embodiment of the present invention (having a core rod inserted therein). FIGS. 37 and 38 are drawings for describing the configuration of the through-member according to the sixth embodiment of the present invention. Next, the lithium ion secondary cell according to the sixth embodiment of the present invention will be described referring to FIGS. 28 through 30 and FIGS. 34 through 38. In these drawings, corresponding configurational elements are given the same symbols and redundant descriptions are appropriately omitted.

In the sixth embodiment, the portion in the through-member 180 that passes through the stacked electrodes (cathode current collectors 11) is divided into three or more. For example, the portion passing through the stacked electrodes is divided into sixteen as shown in FIGS. 34 and 35. Specifically, in the sixth embodiment, the through-member 180 has three or more (e.g., sixteen) through-parts 181.

In the sixth embodiment, the plurality of through-parts 181 are disposed in a circular formation (around a circumference) as shown in FIG. 35. A core rod 190 having a circular cross section (see FIGS. 35 and 36) is inserted into the inner sides of the through-parts 181 disposed in a circular formation. This core rod 190 is configured to be capable of being attached to and detached from the through-member 180. The core rod 190 is used when the through-member 180 is mounted, as is described hereinafter. In the sixth embodiment, the through-parts 181 are flat plates (rectangular strips) having substantially rectangular shapes in cross section, as shown in FIG. 35. Instead of a flat plate, the shape of all the through-members 180 may be a rod that is substantially semicylindrical (substantially semi-ellipsoidal) in cross section, a quadrangular prism, a triangular prism, or another shape.

The bend starting parts 184 (see FIGS. 28 through 30) shown in the fourth embodiment described above are formed in the through-parts 181 of the through-member 180, as shown in FIG. 37. The through-parts 181 of the through-member 180 are bent within the stacked electrodes (cathode current collectors 11). In the sixth embodiment, the through-parts bend at three locations between adjacent electrodes, whereby the bent portions are in a state of protruding outward. These bent portions (the bent parts 183 (deformed portions)) are then in contact with the surfaces of the cathode current collectors 11 (the electrically conductive layers 14).

In the sixth embodiment, the plurality of through-parts 181 are disposed in a circular formation (around a circumference) as shown in FIG. 38, and the bent parts 183 are therefore formed so as to expand in a radial formation. Therefore, the bent parts 183 in the through-member 180 are in contact over more surface area with the surfaces of the cathode current collectors 11 (the electrically conductive layers 14). In this case, a greater number of through-parts 181 of the through-member 180 (the number of necks) will yield a stronger bond with the electrodes, and the contact surface area also increases. Consequently, it is possible to further reduce the contact resistance.

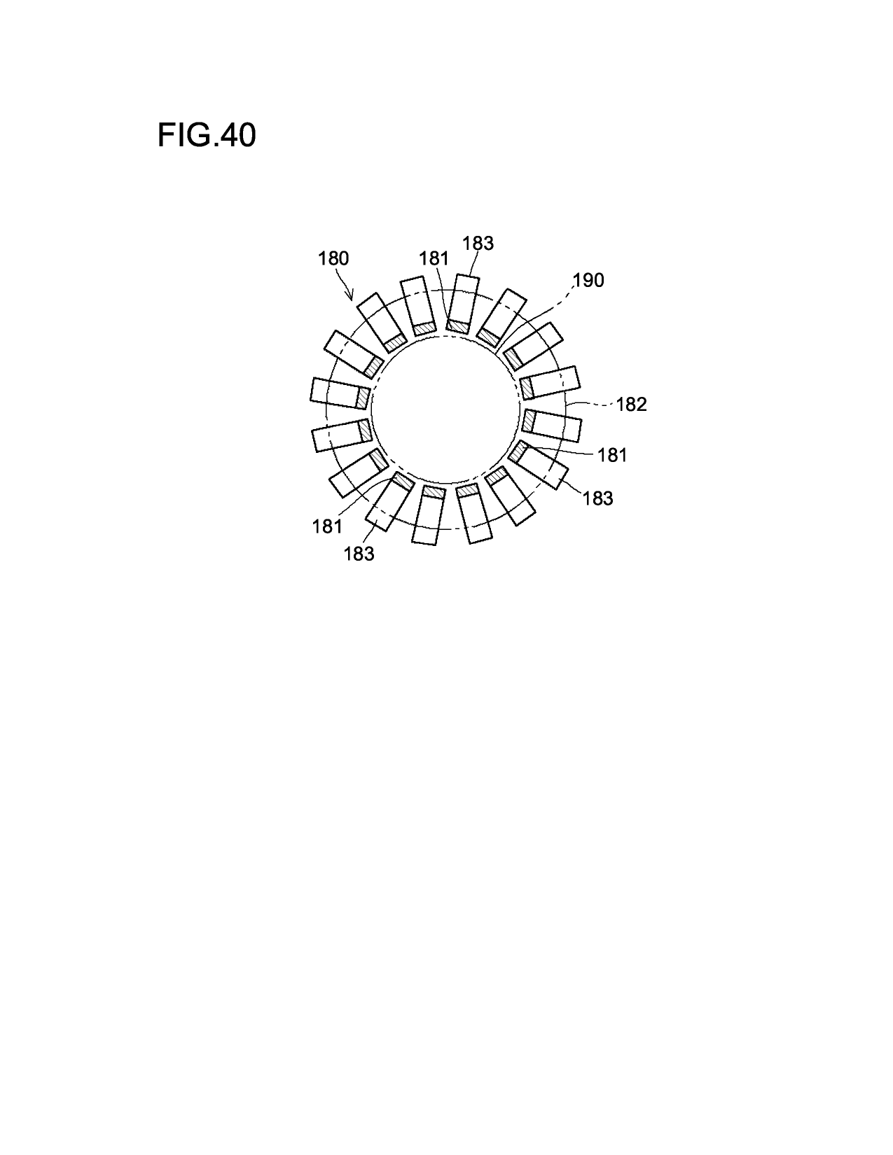

FIGS. 39 and 40 are schematic cross-sectional views showing a method for mounting the through-member according to the sixth embodiment of the present invention. Next, the method for mounting the through-member according to the sixth embodiment will be described referring to FIGS. 28 through 30, FIG. 39, and FIG. 40.

First, the core rod 190 is inserted into the inner sides of the through-parts 181 disposed in a circular formation (around a circumference), as shown in FIGS. 35 and 36. Next, the through-member 180 with the core rod 190 inserted is inserted through the through-holes 11b of the cathode current collectors 11, as shown in FIG. 39. At this time, the gaps between the cathodes 10 (the cathode current collectors 11) are adjusted so that the bending positions (the bend starting parts 184 (see FIGS. 28 through 30)) are positioned between adjacent cathodes 10.

A load in the through direction (the Z direction) is then gradually applied to the through-member 180, as shown in FIG. 40 (see the white arrow). The through-member 180 thereby bends at the bend starting parts 184 (see FIGS. 28 through 30), and the bent parts 183 are positioned between mutually adjacent cathodes 10 (cathode current collectors 11). At this time, the through-parts 181 are suppressed from bending inward by the inserted core rod 190, and the through-parts 181 of the through-member 180 therefore bend so as to protrude outward.

The load continues to be applied until the stacked electrodes (cathode current collectors 11) become a bundle, after which the inserted core rod 190 is taken out. The through-member 180 is thereby mounted in the stacked cathode current collectors 11 in a state such that the bent parts 183 of the through-member 180 are in contact with the surface of the cathode current collectors 11 (the electrically conductive layers 14), as shown in FIG. 37.

The configuration and effects of the sixth embodiment are otherwise identical to the fifth embodiment described above.

The embodiments heretofore disclosed are examples in all points and should not be construed as limiting. The scope of the present invention is shown by the claims rather than the above description of the embodiments, and the scope of the present invention includes meanings equivalent to the scope of the claims as well as all variations within the claims.

For example, in the first through sixth embodiments described above, an example was shown in which the present invention is applied to a lithium ion secondary cell which is one example of a nonaqueous secondary cell, but the present invention is not limited to this example, and the present invention may also be applied to nonaqueous secondary cells other than a lithium ion secondary cell. The present invention can also be applied to nonaqueous secondary cells hereinafter developed.

In the first through sixth embodiments described above, an example was shown in which resin layers in film form were used as the resin layers (insulating layers) of the current collectors, but the present invention is not limited to this example, and resin layers in a form other than a film, e.g., fibers, may be used. Possible examples of fibrous resin layers include layers composed of woven fabric, nonwoven fabric, or the like.

In the first through sixth embodiments described above, an example was shown in which the current collectors on the cathode side were each configured into a multi-layered structure including a resin layer and an electrically conductive layer, but the present invention is not limited to this example, and the current collectors on the anode side may also each be configured into a multi-layered structure including a resin layer and an electrically conductive layer. For example, both the cathodes and anodes may be formed using current collectors having multi-layered structures (triple-layer structures), or either the cathodes alone or the anodes alone may be formed using current collectors having multi-layered structures (triple-layer structures). In cases in which either the cathodes alone or the anodes alone are formed using current collectors having multi-layered structures (triple-layer structures), it is preferable that the cathodes be formed using current collectors having multi-layered structures (triple-layer structures).

In cases in which the current collectors on the anode side are configured into multi-layered structures, the electrically conductive layers are preferably configured from copper or a copper alloy. Specifically, for example, a copper foil or a copper alloy foil having a thickness of approximately 6 to 15 μm can be used as the electrically conductive layers. The electrically conductive layers of the anode current collectors may be configured from a material other than copper or a copper alloy, e.g., nickel, stainless steel, iron, alloys thereof, or the like. The resin layers of the anode current collectors can be the same as the resin layers of the cathode current collectors (that which can be used in the resin layers of the cathode current collectors 11), for example.

In cases in which the current collectors on the anode side are configured into multi-layered structures, a stacked plurality of electrodes (anodes) and a tab electrode are configured so as to be electrically connected using a through-member, similar to the cathodes (cathode current collectors) shown in the first through sixth embodiments described above. In this case, the through-member is preferably configured from copper, a copper alloy, or the like.

In the first through sixth embodiments described above, an example was shown in which a through-member passes through all of the stacked electrodes (current collectors), but the present invention is not limited to this example, and may be configured such that a through-member passes through some of the stacked electrodes (current collectors). For example, the stacked plurality of electrodes (current collectors) may be divided into a plurality of groups, and a through-member may be passed through the electrodes (the current collectors) in each group. Specifically, the through-member described above is preferably configured so as to pass through two or more electrodes (current collectors) consecutively.

In the first through sixth embodiments described above, an example was shown in which the tab electrodes were fixed by welding to the regions where the through-members are provided, but the present invention is not limited to this example, and the tab electrodes may be fixed by welding to regions where through-members are not provided.

In the embodiments described above, the number (through locations) of through-members passing through the current collectors can be varied appropriately. A through-member may be provided to one location, or through-members may be provided to a plurality of locations. The through-members are preferably configured from a metal material, but may be configured from an electrically conductive material other than a metal material. For example, the through-members described above may be configured from an electrically conductive plastic or another electrically conductive resin or the like.

In the first through sixth embodiments described above, an example was shown in which the tab electrodes were connected to the electrodes after the through-members were passed through the electrodes, but the present invention is not limited to this example, and the through-members may be passed through the tab electrodes as well.

In the first through sixth embodiments described above, an example was shown in which a flat square container was used as the external container for accommodating the electrode group, but the present invention is not limited to this example, and the shape of the external container need not be a flat square shape. For example, the external container described above may be in the shape of a thin flat tube, a cylinder, a square tube, or the like. In cases of large lithium ion secondary cells, the container is often used as a cell pack and is therefore preferably thin and flat or square. Furthermore, the external container described above may be an external container that uses a laminate sheet or the like, for example, instead of a metal canister.

In the first through sixth embodiments described above, an example was shown in which the cathodes (the cathode active material layers) and the anodes (the anode active material layers) were configured so as to be the same size, but the present invention is not limited to this example, and the cathodes and anodes may be configured in mutually different sizes. For example, the anodes (the anode active material layers) may be configured to be larger than the cathodes (the cathode active material layers), or the cathodes (the cathode active material layers) may be configured to be larger than the anodes (the anode active material layers). In cases in which the cathodes and anodes are configured in mutually different sizes, it is preferable that the anodes (the anode active material layers) be configured so as to be larger than the cathodes (the cathode active material layers). With such a configuration, the formed regions of the cathode active material layers (the cathode active material regions) are covered by the formed regions of the anode active material layers (the anode active material regions) of larger surface area, whereby there can be a greater allowable range of stacking misalignment.

In the first through sixth embodiments described above, the size, shape, and other characteristics of the external container can be varied in many ways. The shape of the electrodes (cathodes, anodes), their dimensions, number used, and other characteristics can also be appropriately varied. Furthermore, the shape, dimensions, and other characteristics of the separators can also be appropriately varied. Various shapes can be used as the shape of the separators, e.g., a perfect square, an oblong square or other rectangle, a polygon, a circle, and the like.

In the first through sixth embodiments described above, an example was shown in which an active material layer was formed on both sides of each current collector, but the present invention is not limited to this example, and another option is to form an active material layer on only one side of each current collector. Electrodes (cathodes, anodes) having an active material layer formed on only one side of their current collector may be included in part of the electrode group.

In the first through sixth embodiments described above, an example was shown in which a nonaqueous electrolytic solution was used as the electrolyte of the lithium ion secondary cell, but the present invention is not limited to this example, and instead of a nonaqueous electrolytic solution, a gel electrolyte, a polymer solid electrolyte, an inorganic solid electrolyte, a molten salt, or the like, for example, may be used as the electrolyte.

In the first through third embodiments described above, an example was shown in which a through-member having a columnar shaft was used, but the present invention is not limited to this example, and the shaft of the through-member may be in the shape of a tube (e.g., a cylinder or the like). In this case, the through-member can be configured into the shape of a rivet or eyelet. The shaft of the through-member may be a shape other than a column (cylinder). For example, the shaft may be a prism (a square tube), an ellipsoidal column (an ellipsoidal tube), or the like.

In the first through third embodiments described above, an example was shown in which asperities were provided over virtually the entire surface of the through-member (the shaft), but the present invention is not limited to this example, and there may be regions were asperities are not provided in part of the surface of the through-member (the shaft).

In the fourth through sixth embodiments described above, an example was shown in which the bend starting parts of the through-member were configured from cut-outs or concavities, but the present invention is not limited to this example, and the bend starting parts may have a configuration other than cut-outs or concavities. It is also effective to bend the through-member and form creases in the through-member in advance.

In the fourth embodiment described above, an example was shown in which the through-member was configured without asperities provided in the surface, but the present invention is not limited to this example, and the through-member may be configured with asperities provided in the surface. A possible example of the asperities provided to the surface of the through-member is the same asperities as those shown in the first through third embodiments described above. In cases in which asperities are provided to the surface of the through-member in the fourth embodiment, the bent parts are preferably machined (for example, reduced in thickness (increase the depth of the concave portions)) to bend more readily than other portions of the asperities.

Embodiments obtained by appropriately combining the techniques disclosed above are also included within the technological scope of the present invention.

What is claimed is:

1. A nonaqueous secondary cell comprising:
an electrode including a current collector that has a multi-layered structure in which an electrically conductive layer is formed on both sides of an insulating layer, and an active material layer formed on the current collector;
a through-member configured from an electrically conductive material and passing through the current collector in the thickness direction; and
a tab electrode electrically connected with the electrode;
a plurality of the electrodes being stacked; and
asperities being provided on the surface of the through-member.

2. The nonaqueous secondary cell of claim 1;
the height of the asperities being in a range of 0.1 μm to 5 mm.

3. The nonaqueous secondary cell of claim 1;
the asperities being provided at a predetermined pitch relative to the through direction of the through-member; and
the pitch of the asperities being 0.1 to two times the thickness of the current collector.

4. The nonaqueous secondary cell of claim 1;
a thread groove being formed in the through-member; and
the asperities being provided in the surface of the through-member by the formation of the thread groove.

5. A nonaqueous secondary cell comprising:
an electrode including a current collector that has a multi-layered structure in which an electrically conductive layer is formed on both sides of an insulating layer, and an active material layer formed on the current collector;
a through-member configured from an electrically conductive material and passing through the current collector in the thickness direction; and
a tab electrode electrically connected with the electrode;
a plurality of the electrodes being stacked;
the through-member being deformed within the stacked electrodes; and
the deformed portion of the through-member being in contact with the current collector.

6. The nonaqueous secondary cell of claim 5;
the through-member having a bent part that is bent within the stacked electrodes.

7. The nonaqueous secondary cell of claim 6;
the bent part of the through-member being positioned between adjacent electrodes.

8. The nonaqueous secondary cell of claim 6;
a bend starting part where bending begins being formed in the through-member.

9. The nonaqueous secondary cell of claim 8;
the bend starting part comprising a cut-out or a concavity.

10. The nonaqueous secondary cell of claim 8;
the through-member having a plurality of through-parts passing through the stacked electrodes; and
the bend starting part being formed in at least one of the plurality of through-parts.

11. The nonaqueous secondary cell of claim 10;
the through-parts being formed in the through-member by dividing the portion that passes through the stacked electrodes.

12. The nonaqueous secondary cell of claim 11;
there being two to sixteen divisions of the portion in the through-member that passes through the stacked electrodes.
